(19) United States
(12) Patent Application Publication
(10) Pub. No.: US 2024/0069457 A1
(43) Pub. Date: Feb. 29, 2024

(54) TONER AND TWO-COMPONENT DEVELOPER

(71) Applicant: CANON KABUSHIKI KAISHA, Tokyo (JP)

(72) Inventors: RYUJI MURAYAMA, Chiba (JP); SHIN KITAMURA, Ibaraki (JP); TORU TAKAHASHI, Ibaraki (JP); DAISUKE TSUJIMOTO, Tokyo (JP); RYUICHIRO MATSUO, Ibaraki (JP); HITOSHI SANO, Chiba (JP); NOBUYUKI FUJITA, Tokyo (JP); SHUJI YAMADA, Chiba (JP); YUKA GUNJI, Ibaraki (JP); TAKAKUNI KOBORI, Ibaraki (JP); YOSHIHIRO OGAWA, Ibaraki (JP); ATSUHIKO OHMORI, Kanagawa (JP); HIROKI KAGAWA, Shizuoka (JP); KEISUKE ADACHI, Tokyo (JP); TOMOKO SUGITA, Kanagawa (JP)

(21) Appl. No.: 18/493,903

(22) Filed: Oct. 25, 2023

Related U.S. Application Data
(63) Continuation of application No. PCT/JP2022/019410, filed on Apr. 28, 2022.

(30) Foreign Application Priority Data
Apr. 28, 2021 (JP) 2021-076193
Mar. 31, 2022 (JP) 2022-058265

(51) Int. Cl. G03G 9/097; G03G 9/08; G03G 9/087; G03G 9/107; G03G 9/113

(52) U.S. Cl. CPC G03G 9/09725; G03G 9/0819; G03G 9/0821; G03G 9/08755; G03G 9/1075; G03G 9/1133

(57) ABSTRACT

The toner contains binder resin-containing toner particles and silica fine particle S1, wherein the weight-average particle diameter of the toner is 4.0-15.0 μm, both inclusive, peaks originating with the silica fine particle S1 are observed in 29 Si-NMR measurement of the silica fine particle S1, and, in the spectrum obtained by ²⁹Si CP/MAS NMR or ²⁹Si DD/MAS NMR, the peak area of a peak corresponding to the D1 unit structure in the silica fine particle S1, the peak area of a peak corresponding to the D2 unit structure in the silica fine particle S1, and the peak area of a peak corresponding to the Q unit structure in the silica fine particle S1 satisfy a prescribed relationship.

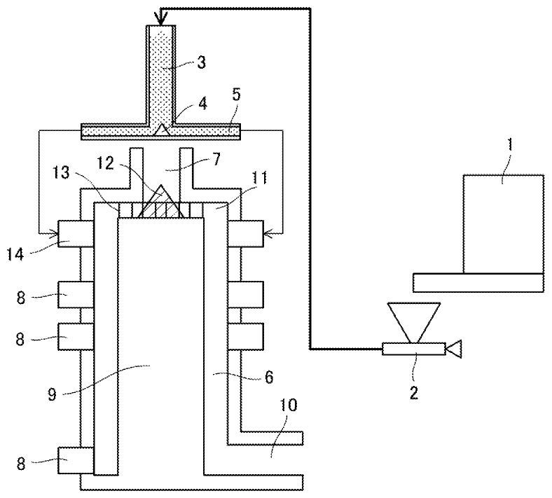

### CROSS-REFERENCE TO RELATED APPLICATION

This is a continuation of International Application No. PCT/JP2022/019410, filed on Apr. 28, 2022, and designated the U.S., and claims priority from Japanese Patent Application No. 2021-076193 filed on Apr. 28, 2021, and Japanese Patent Application No. 2022-058265 filed on March 31, 2022, the entire contents of which are incorporated herein by reference.

### BACKGROUND OF THE INVENTION

### Field of the Invention

The present disclosure relates to a toner and a two-component developer for developing electrostatic images used in electrophotography, electrostatic recording, and the like.

### Description of the Related Art

In recent years, electrophotographic full-color copiers have become widespread, and application thereof to a printing market has started. In the printing market, high speed, high image quality and high stability are required.

In order to increase the speed of electrophotographic copiers, it is necessary to fix the toner with a smaller amount of heat, and it is important to lower the melt viscosity of the toner due to heat during fixing. Further, in order to achieve high image quality, it is necessary that the charging speed of the toner be high and that the charging performance be stable regardless of the usage environment. Furthermore, in the printing market, there is a demand for copiers with high stability in which there is little change in image quality and image density even in continuous use for a long period of time.

Various studies have been conducted to adjust the melt viscosity of toners in order to improve the fixing performance thereof. For example, Japanese Patent Application Publication No. H5-107803 discloses a toner in which the fixing performance is improved by reducing the melt viscosity of a toner resin in a constant temperature range.

In order to stabilize the charging characteristics of toner, external additives have been studied. For example, Japanese Patent Application Publication No. 2004-219609 discloses a toner in which charging characteristics are improved by controlling the free ratio of silica treated with silicone oil.

In order to achieve high stability with little change in image quality and image density of copiers, studies have been conducted to adjust the state of attachment of external additives to the toner particle surface. For example, Japanese Patent Application Publication No. 2011-215310 discloses a toner in which when silica particles are externally added to a toner particle, the fixed attachment to the toner particle is improved by adjusting the external addition conditions and strength.

### SUMMARY OF THE INVENTION

There are several problems with toners that are to be resolved in order to satisfy high speed, high image quality, and high stability of copiers.

Where the viscosity of toner is lowered in order to improve the fixing performance in response to the increased speed of the main unit, the heat resistance of the toner tends to decrease, and toner aggregates are likely to be formed. Where the aggregates are present in the toner in a developing device, when a halftone image or the like is output, unevenness in density called development spots is likely to occur in the image.

In addition, where the charging performance of the toner fluctuates depending on the usage environment, the image density tends to fluctuate or toner development in non-image areas, which is called fogging, tends to occur.

Furthermore, when a large number of images with extremely low or high print percentage are printed in succession, the charging of the toner is not stable and may become excessively high or low, often resulting in fluctuations in image density or fogging.

The toners disclosed in Japanese Patent Application Publication No. H5-107803, Japanese Patent Application Publication No. 2004-219609 and Japanese Patent Application Publication No. 2011-215310 are insufficient to simultaneously satisfy the suppression of the occurrence of toner aggregates, the environmental stability of charging, and the stability during continuous large-volume printing, and further improvement thereof is needed.

The present disclosure provides a highly stable toner in which toner aggregates are less likely to occur, charging performance is stable regardless of usage environment, and charging performance does not fluctuate even in continuous large-volume printing. Also, a toner is provided in which development spots do not occur, fluctuation in image density is small regardless of the usage environment and the number of printed sheets, and little fogging occurs.

The present disclosure relates to a toner comprising
a toner particle comprising a binder resin, and
a silica fine particle S1 on a surface of the toner particle, wherein
the toner has a weight-average particle diameter of 4.0 μm or more and 15.0 μm or less,
in ²⁹Si-NMR measurement of the silica fine particle S1, peaks corresponding to the silica fine particle S1 are observed,

in a spectrum obtained by a 29 Si-NMR·CP/MAS method for the silica fine particle S1, a peak corresponding to a D1 unit structure of the silica fine particle S1, a peak corresponding to a D2 unit structure of the silica fine particle S1, and a peak corresponding to a Q unit structure of the silica fine particle S1 are present, and a peak area of the peak corresponding to the D1 unit structure, a peak area of the peak corresponding to the D2 unit structure, and a peak area of the peak corresponding to the Q unit structure are denoted by S_{CP}D1, S_{CP}D2, and S_{CP}Q, respectively, and in a spectrum obtained by a ²⁹Si-NMR·DD/MAS method for the silica fine particle S1, a peak corresponding to a D1 unit structure of the silica fine particle S1, a peak corresponding to a D2 unit structure of the silica fine particle S1, and a peak corresponding to a Q unit structure of the silica fine particle S1 are present, and a peak area of the peak corresponding to the D1 unit structure, a peak area of the peak corresponding to the D2 unit structure, and a peak area of the peak corresponding to the Q unit structure are denoted by S_{DD}D1, S_{DD}D2, and S_{DD}Q, respectively, the ratio (AB) of A given by a following formula (1) to B given by a following formula (2) is 4.0 or more and 14.0 or less,

A={(S_{CP}D1+S_{CP}D2)/S_{CP}Q}×100

B={(S_{DD D}1+S_{DD}D2)/S_{DD}Q}×100, and

where in a spectrum obtained by the ²⁹Si-NMR·DD/MAS method for a sample obtained by washing the silica fine particle S1 with hexane, a peak corresponding to the D1 unit structure of the sample, a peak corresponding to the D2 unit structure of the sample, and a peak corresponding to the Q unit structure of the sample are present, and a peak area of the peak corresponding to the D1 unit structure, a peak area of the peak corresponding to the D2 unit structure, and a peak area of the peak corresponding to the Q unit structure are denoted by S_{DDW}D1, S_{DDW}D2, and S_{DDW}Q, respectively,

a value of C given by a following formula (3) is 1.0 or more;

C={(S_{DDW}D1+S_{DDW}D2)/S_{DDW}Q}×100.

According to the present disclosure, it is possible to provide a highly stable toner in which toner aggregates are less likely to occur, charging performance is stable regardless of usage environment, and charging performance does not fluctuate even in continuous large-volume printing. Also, it is possible to provide a toner in which development spots do not occur, fluctuation in image density is small regardless of the usage environment and the number of printed sheets, and little fogging occurs. Further features of the present invention will become apparent from the following description of exemplary embodiments with reference to the attached drawings.

### BRIEF DESCRIPTION OF THE DRAWINGS

The Figure is a schematic diagram of a heat treatment apparatus.

### DESCRIPTION OF THE EMBODIMENTS

Unless specifically indicated otherwise, in the present disclosure the expressions “from XX to YY” and “XX to YY” that show numerical value ranges refer to numerical value ranges that include the lower limit and upper limit that are the end points. When numerical value ranges are provided in stages, the upper limits and lower limits of the individual numerical value ranges may be combined in any combination.

Also, a monomer unit refers to a reacted form of a monomer substance in a polymer.

For example, one unit is one carbon-carbon bond section in the main chain of polymerized vinyl-based monomer in the polymer. A vinyl-based monomer can be represented by a following formula (Z).

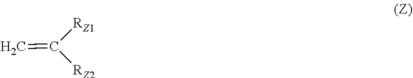

In formula (Z), R_{Z1} represents a hydrogen atom or an alkyl group (preferably an alkyl group having 1 to 3 carbon atoms, more preferably a methyl group), and R_{Z2} represents an arbitrary substituent.

The inventors of the present invention have made studies with the object of obtaining a toner in which toner aggregates are less likely to occur, charging performance is stable regardless of usage environment, and charging performance does not fluctuate even in continuous large-volume printing. As a result, it was found that by using a toner to which silica fine particles having the configuration of the present disclosure are externally added, an excellent toner that has never been obtained before can be obtained.

The reason why the above effects are obtained is as follows.

The external additives that are present on the toner surface greatly affect powder characteristics such as toner aggregation and flow, as well as charging stability. In order to satisfy these toner performances, it is effective to use hydrophobized fine silica particles as an external additive. In particular, it is preferable that the surface be treated with a treatment agent having a siloxane structure such as silicone oil. Furthermore, it was found to be important that a siloxane structure that adheres so strongly that it cannot be removed from the silica fine particles by washing with hexane, or that is chemically bonded to the silica microparticles be present and that the molecular mobility of the siloxane structure be within a specific range.

The specific feature of the siloxane structure present on the surface of silica fine particle is that the charging characteristics are less susceptible to environmental fluctuations. Therefore, when added to the toner particle, such siloxane structure has a strong action of enhancing the environmental stability of charging of the toner.

In addition, the molecular chain of the siloxane structure present on the surface of silica fine particles contained in the toner tends to move thermally and interact with the binder resin components contained in the toner particle. Therefore, by controlling the molecular mobility of the siloxane molecular chain within an appropriate range, the adhesive force between the silica fine particles and the toner particle can be strengthened.

Meanwhile, where the molecular mobility of the siloxane molecular chain is excessively high, the silica fine particles may tend to aggregate with each other, or the toner may tend to aggregate. As a result, when the toner is allowed to stand in a high-temperature and high-humidity environment for a long period of time, toner aggregates are formed, and when an image is output, unevenness in density called development spots may occur. In addition, the charging of the toner tends to be unstable due to aggregation of the silica fine particles.

Where the molecular mobility of the siloxane molecular chain is too low, aggregation of the silica fine particles and the toner particles is unlikely to occur, but the attachment force between the silica fine particles and the toner particle is weakened, and when the toner is triboelectrically charged, the silica fine particles may move on the toner particle surface and the state of presence of the silica fine particles may become unbalanced. As a result, the charging performance of the toner may become unstable in continuous large-volume printing.

The molecular mobility of the siloxane molecular chain present on the surface of the silica fine particle S1 used in the present disclosure is considered as follows.

In ²⁹Si-solid NMR measurement, there are two measurement methods, DD/MAS measurement method and CP/MAS measurement method, and these two measurement methods are used in the present disclosure. The respective measurement methods are hereinafter referred to as ²⁹Si-NMR·DD/MAS method and ²⁹Si-NMR·CP/MAS method.

First, the bonding state of a silicon atom will be explained. The bonding states of a silicon atom discussed in this disclosure are a D1 unit structure, a D2 unit structure, and a Q unit structure.

The D1 unit structure is a unit structure in which two oxygen atoms are bonded to a silicon atom, and only one of the two oxygen atoms is further bonded to a silicon atom. For example, it is the structure of a silicon atom in the range enclosed by the square in the following formula (A).

The D2 unit structure is a unit structure in which two oxygen atoms are bonded to a silicon atom, and both oxygen atoms are further bonded to silicon atoms. For example, it is the structure of a silicon atom in the range enclosed by the square in the following formula (B).

The D unit structure is a combination of the D1 unit structure and the D2 unit structure, in which two oxygen atoms are bonded to a silicon atom, and anything may be bonded to the oxygen atoms.

The Q unit structure is a unit structure in which four oxygen atoms are bonded to a silicon atom, and anything can be bonded to the oxygen atoms. For example, it is a structure of a silicon atom of the following formula (C).

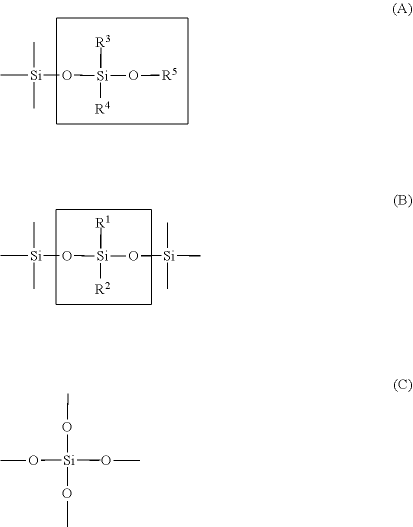

(R¹, R², R³, R⁴, and R⁵ in the formulas each independently represent a hydrogen atom or an alkyl group having 1 or 2 carbon atoms.)

In the ²⁹Si-NMR·DD/MAS measurement method, all silicon atoms in the measurement sample are observed, so information on the silicon atom content can be obtained.

In the spectrum obtained by ²⁹Si-NMR DD/MAS measurement, the peak area corresponding to the D1 unit structure is denoted by S_{DD}D1, the peak area corresponding to the D2 unit structure is denoted by S_{DD}D2, and the peak area corresponding to the Q unit structure is denoted by S_{DD}Q. At this time, the value B calculated by the following formula means the abundance ratio of the D unit structure in the silica fine particles. The value of B increases, for example, when the number of D unit structures contained in the surface treatment agent to be reacted with the surface of the silica fine particle substrates is increased.

B={(S_{DD}D1+S_{DD}D2)/S_{DD}Q}×100

B is preferably 5.0 to 15.0, more preferably 6.0 to 12.0, still more preferably 7.0 to 10.0.

Meanwhile, in the ²⁹Si-NMR·CP/MAS measurement, since the measurement is performed while magnetizing through the hydrogen atoms present in the vicinity of the silicon atoms, the silicon atoms present in the vicinity of the hydrogen atoms can be observed with high sensitivity. The presence of hydrogen atoms in the vicinity of silicon atoms means that the molecular mobility of the measurement sample is low. That is, the lower the molecular mobility of the measurement sample and the larger the amount thereof, the better the sensitivity with which the silicon atoms can be observed. That is, information on the D unit structure obtained by ²⁹Si-NMR·CP/MAS measurement includes not only the amount of the D unit structure but also information on the molecular mobility of the D unit structure.

In the spectrum obtained by ²⁹Si-NMR·CP/MAS measurement, the peak area corresponding to the D1 unit structure is denoted by S_{CP}D1, the peak area corresponding to the D2 unit structure is denoted by S_{CP}D2, and the peak area corresponding to the Q unit structure is denoted by S_{CP}Q. At this time, the value A calculated by the following formula is the content ratio of the D unit structure in which silicon atoms with low molecular mobility are emphasized. The value of A increases, for example, when a large number of structures caused by a surface treatment agent with low molecular mobility are present on the surface of the silica fine particle substrates.

A={(S_{CP}D1+S_{CP}D2)/S_{CP}Q}×100

By calculating the ratio (AB) using the above A and B, information on the molecular mobility derived from the surface-treated D unit structure can be obtained.

That is, it means that the larger the value of A/B, the lower the molecular mobility of the D unit structure derived from the surface treatment agent.

In the present disclosure, it is important that the ratio (A/B) be 4.0 or more and 14.0 or less. A/B is preferably 6.0 or more and 14.0 or less, more preferably 8.0 or more and 13.0 or less, and still more preferably 10.0 or more and 12.0 or less.

When the silica fine particle S1 satisfying these ranges are added to the toner particle, it becomes possible to obtain a toner which excels in environmental stability of the charging of the toner and in which the generation of toner aggregates is suppressed, development spots are less likely to occur, and charging performance is stable even in continuous large-volume printing.

Furthermore, in the present disclosure, in the 29 Si-NMR·DD/MAS method for a sample obtained by washing the silica fine particle S1 with hexane, a peak area of the peak corresponding to the D1 unit structure is denoted by S_{DDW}D1, a peak area of the peak corresponding to the D2 unit structure is denoted by S_{DDW}D2, and a peak area of the peak corresponding to the Q unit structure is denoted by S_{DDW}Q. At this time, it is important that a value of C calculated by the following formula be 1.0 or more.

C={(S_{DDW}D1+S_{DDW}D2)/S_{DDW}Q}×100

The presence of peaks derived from the D1 unit structure and the D2 unit structure in the silica fine particle S1 after washing with hexane indicates that a compound having a siloxane structure chemically bonded or very strongly attached to the surface of the silica fine particle S1 is present in a certain amount or more. C is preferably 3.0 or more, more preferably 5.0 or more. Although the upper limit is not particularly limited, it is preferably 15.0 or less, more preferably 12.0 or less, still more preferably 10.0 or less, and even more preferably 9.0 or less. By having more siloxane structures that are chemically bonded or strongly attached to the surface of the silica fine particle S1, it becomes easier to achieve stabilization of charging performance.

When a peak corresponding to the Q unit structure is observed in the spectrum obtained by the 29 Si-NMR·DD/MAS method, it can be determined that “a peak corresponding to the silica fine particle S1 was observed”.

The washing of the silica fine particle S1 with hexane is performed by the method described hereinbelow.

When it is necessary to separate the silica fine particle from the toner particle when measuring the physical properties of the silica fine particle, the measurement can be performed after separation by the method described hereinbelow. In the separation method described hereinbelow, since the separation is performed in an aqueous medium, the silicon compound is not eluted into the medium, and the silica fine particle can be separated from the toner particle while maintaining the physical properties before the separation step. Therefore, the physical property values measured using the silica fine particle separated from the toner particle are substantially the same as the physical property values measured using the silica fine particle before external addition.

Further, when an external additive other than the silica fine particle S1 is externally added to the toner, the silica fine particle S1 and the other external additive can be separated by performing a centrifugal separation of the external additives separated from the toner by the above-described method. Even when a plurality of types of silica fine particles is externally added to the toner, where the particles have different particle size ranges, they can be separated by centrifugal separation. For example, separation can be performed at 40,000 rpm for 20 min by using CS120FNX manufactured by Hitachi Koki Co., Ltd.

<Method for Washing Silica Fine Particle S1 with Hexane>

A total of 1.0 g of silica fine particles is weighed into a 50 ml screw tube, and 20 ml of normal hexane is added. Then, extraction is performed for 10 min with an ultrasonic homogenizer (VP-050 manufactured by TAITEC Corporation) at an intensity of 20 (output 10 W). The obtained extract is separated by a centrifugal separator, the supernatant is removed, normal hexane is distilled off from the obtained wet sample by an evaporator, and silica particles after washing with hexane are obtained.

<Measurement Method of NMR>

As a pretreatment for NMR measurement, the silica fine particle S1 are separated from the toner particle by the following method.

[Method for Separating Silica Fine Particles Si from Toner Particle]

A total of 20 g of a 10% by weight aqueous solution of “Contaminon N” (a pH 7 neutral detergent for cleaning precision measuring instruments that consists of a nonionic surfactant, an anionic surfactant, and an organic builder) is weighed into a 50 mL vial, and 1 g of toner is mixed therewith.

The vial is set in “KM Shaker” (model: V .SX) manufactured by Iwaki Industry Co., Ltd., the speed is set to 50, and shaking is performed for 30 sec. As a result, the fine silica particle S1 migrates from the toner particles surface into the aqueous solution.

Thereafter, in the case of a magnetic toner containing magnetic bodies, the silica fine particle S1 that has migrated to the supernatant liquid are separated while the toner particles are constrained using a neodymium magnet, and the precipitated toner is vacuum-dried (40° C./24 h) to obtain a sample.

In the case of a non-magnetic toner, a centrifuge (H-9R; manufactured by Kokusan Co., Ltd.) (1000 rpm for 5 min) is used to separate the toner particle and the fine silica particle S1 transferred to the supernatant.

Next, solid-state 29 Si-NMR measurement of the silica fine particle collected from the toner is performed under the measurement conditions shown hereinbelow. NMR measurement of silica particle after washing with hexane can also be performed in the same manner as described below.

[²⁹Si-NMR Measurement Method]

The specific measurement conditions for solid-state ²⁹Si-NMR are as follows.

### Device: JNM-ECA400 (JEOL RESONANCE)

Calibration: TMS (tetramethylsilane) at 0 ppm
Temperature: room temperature
Measurement method: DD/MAS method, ²⁹Si, 45°
Sample tube: zirconia 8.0 mmφ
Sample: a test tube filled with fine silica particles in powder form
Sample rotation speed: 6 kHz
relaxation delay: 90 sec

### Scan: 1000

In addition, the CP/MAS measurement conditions for solid-state ²⁹Si-NMR (solid) are as follows. Device: JNM-ECA400 (JEOL RESONANCE)

Temperature: room temperature
Measurement method: CP/MAS method, ²⁹Si, 45°
Sample tube: zirconia 8.0 mmφ
Sample: a test tube filled with fine silica particle in powder form
Sample rotation speed: 6 kHz
relaxation delay: 5 sec

### Scan: 10,000

After the above measurement, a plurality of silane components with different substituents and bonding groups are peak-separated into the following M unit, D unit, T unit, and Q unit by curve fitting from the solid-state ²⁹Si-NMR spectrum of the silica fine particle.

Curve fitting is performed using JNM-EX400 software EXcalibur for Windows (registered trademark) version 4.2 (EX series) manufactured by JEOL Ltd. “1D Pro” from the menu icon is clicked to load the measurement data. Next, “Curve fitting functinon” is selected from “Command” on the menu bar to perform curve fitting. Curve fitting is performed for each component so that the difference (composite peak difference) between the composite peak obtained by combining the peaks obtained by curve fitting and the peak of the measurement result is minimized.

M unit: (Rᵢ)(Rⱼ)(Rₖ)SiO_{1/2} Formula (4)

D unit: (R_{g})(Rₕ)Si(O_{1/2})₂ Formula (5)

T unit: RₘSi(O_{1/2})₃ Formula (6)

Q unit: Si(O_{1/2})₄ Formula (7)

Rᵢ, Rⱼ, Rₖ, R_{g}, Rₕ, and Rₘ in formulas (4), (5), and (6) are each a silicon-bonded alkyl group such as a hydrocarbon group having 1 to 6 carbon atoms, a halogen atom, a hydroxy group, an acetoxy group, an alkoxy group, or the like.

Further, for the D unit peak, waveform separation is performed using the Voigt function, and the area of the peak of more than −19 ppm and −17 ppm or less corresponding to the D1 unit structure and the area of the peak of at least −23 ppm and not more than −19 ppm corresponding to the D2 unit structure are calculated.

The area of the peak of −130 ppm to −85 ppm corresponding to the Q unit structure is also calculated.

This calculation is performed for the spectrum obtained by the DD/MAS method and the spectrum obtained by the CP/MAS method, and S_{CP}D1, S_{CP}D2, S_{CP}Q, S_{DD}D1, S_{DD}D2, and S_{DD}Q are calculated. Further, A, B and C are calculated.

The treatment agent for treating the surface of the silica fine particle substrates is not particularly limited as long as the silica fine particle S1 satisfying the requirements for the D unit structure and the Q unit structure are obtained. However, it is preferable to use a treatment agent containing a siloxane structure.

In the present disclosure, when silica file particle is surface-treated with a surface treatment agent such as silicone oil, they are referred to as silica fine particle including the portion derived from the surface treatment agent. In addition, silica fine particle before being surface-treated is also referred to as silica fine particle substrate.

Examples of treatment agents containing a siloxane bond include silicon oils such as dimethyl silicone oil, methylhydrogen silicone oil, methylphenyl silicone oil, alkyl-modified silicone oil, chloroalkyl-modified silicone oil, chlorophenyl-modified silicone oil, fatty acid-modified silicone oil, polyether-modified silicone oil, alkoxy-modified silicone oil, carbinol-modified silicone oil, amino-modified silicone oil, fluorine-modified silicone oil, as well as reactive silicone oil having reactive functional groups at double terminals thereof, reactive silicone oil having reactive functional groups at side chains thereof, reactive silicone oil having reactive functional groups at double terminals and side chains thereof, and the like.

Of these treatment agents, it is preferable to use double-terminal reactive silicone oil or double-terminal and side-chain reactive silicone oil. These silicone oils are preferable because the terminal of the silicone oil and the silanol of the silica fine particle substrate react with each other and, therefore, the surface treatment of the silica fine particle substrate can be performed under relatively mild conditions, so that that surface treatment making it possible to obtain a certain molecular chain length and not reducing the mobility too much is easily performed.

The treatment agent preferably used can be exemplified by a well-known silicone oil such as modified silicone oil in which a methyl group at the terminal and/or side chain of the molecular chain of dimethyl silicone oil is substituted with a functional group such as a hydrogen atom, a phenyl group, a carbinol group, a hydroxy group, a carboxyl group, an epoxy group, and the like. Among these, where the substitution is performed with a highly reactive functional group, it is easy to achieve the molecular mobility and impart reactivity to the silica fine particle substrate required for the present invention. Therefore, the functional group is preferably at least one selected from the group consisting of hydroxyl group, epoxy group and carbinol group. Any other surface treatment agent may be used as long as the silica fine particle S1 can be produced by controlling the reaction conditions.

A modified silicone oil in which at least both terminal methyl groups are substituted with functional groups is preferred. For example, a preferred modified silicone oil is represented by the following formula (Z).

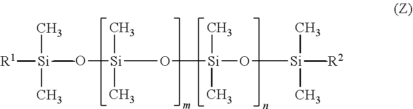

(In formula (Z), R¹ and R² are each independently a carbinol group, a hydroxy group, an epoxy group, a carboxy group, or a hydrogen atom, and R³ is a carbinol group, a hydroxy group, an epoxy group, a carboxy group, an alkyl group (having 1 or 2 carbon atoms, preferably 1 carbon atom), or a hydrogen atom. n and m are the average number of repeating units, and n is 1 or more and 200 or less (preferably 1 to 10, more preferably 1 to 5), and m is 1 or more and 200 or less (preferably 10 to 150, more preferably 15 to 100)).

R¹ and R² are preferably each independently a carbinol group, a hydroxy group, or an epoxy group.

R³ is preferably a carbinol group, a hydroxy group, an epoxy group, or an alkyl group (having 1 or 2 carbon atoms, preferably 1 carbon atom).

Although the kinematic viscosity of the modified silicone oil at a temperature of 25° C. is not particularly limited, it is preferably 20 mm²/s to 100 mm²/s, more preferably 30 mm²/s to 60 mm²/s.

Although the functional group equivalent of the modified silicone oil is not particularly limited, it is preferably 300 g/mol to 2000 g/mol, more preferably 500 g/mol to 1000 g/mol.

Although the treatment temperature varies depending on the reactivity of the surface treatment agent used, it is preferably 250° C. or more and 380° C. or less, more preferably 280° C. or more and 350° C. or less, and still more preferably 300° C. or more and 330° C. or less. The treatment time varies depending on the treatment temperature and the reactivity of the surface treatment agent used, but is preferably 5 min or more and 300 min or less, more preferably 30 min or more and 300 min or less, and still more preferably 120 min or more and 300 min or less. It is preferable that the treatment temperature and the treatment time of the surface treatment be within the above ranges from the viewpoint of sufficiently reacting the treatment agent with the silica fine particle substrate.

Although the amount of the surface treatment agent varies depending on the reactivity etc. of the surface treatment agent used, it is preferably 0.5 parts by mass or more and 10 parts by mass or less, more preferably 1.0 part by mass or more and 5.0 parts by mass or less with respect to 100 parts by mass of the silica fine particle substrate. Where the amount of the surface treatment agent is sufficient to render the silica fine particles sufficiently hydrophobic and is not excessively large, the effects of stabilizing the charging performance and reducing development spots, which are the effects of the present invention, are likely to be obtained.

By treating the surface of the silica fine particle substrate by the method described above, the D unit structure is easily formed on the silica fine particle substrate surface so that A, B, and C satisfy specific values. Along with this, the silica fine particles are hydrophobized. Therefore, by evaluating the moisture adsorption amount on the surface of the silica fine particle S1, the result can be used as an index of how much the surface of the silica fine particle S1 is coated with the siloxane structure.

The moisture adsorption amount of the silica fine particle S1 is preferably 0.010 cm³/m² to 0.100 cm³/m², more preferably 0.010 cm³/m² to 0.050 cm³/m², even more preferably 0.010 cm³/m² to 0.040 cm³/m², and still more preferably 0.010 cm³/m² to 0.030 cm³/m² per 1 m² of BET specific surface area at a temperature of 30° C. and a relative humidity of 80%.

As a result, it is possible to quickly generate a necessary quantity of charge, avoid excessive localization of the generated charge, and adequately diffuse the charge to the surroundings, thereby achieving better charging stability. Furthermore, even when the environment changes, fluctuations in image density are small, and changes in image density during continuous printing can be further suppressed.

The moisture adsorption amount of the silica fine particle S1 can be increased by lowering the degree of hydrophobizing treatment and increasing the residual amount of silanol groups present on the surface of the silica fine particle substrate. Also, the moisture adsorption amount of the silica fine particle S1 can be reduced by increasing the degree of hydrophobizing treatment and reducing the residual amount of silanol groups present on the surface of the silica fine particle substrate.

Further, after surface-treating the silica fine particle substrate by the above-described method, further treatment may be performed using the above-described treatment agent containing a siloxane bond. The method of treatment is not particularly limited.

<Method for Measuring Moisture Adsorption Amount>

The moisture adsorption amount of the silica fine particle S1 is measured by an adsorption equilibrium measuring device (BELSORP-aqua3: manufactured by Bell Japan, Ltd.). This device is for measuring the amount of adsorption of target gas (water vapor).

(Degassing)

The moisture adsorbed on the sample is degassed before measurement. A cell, a filler lot, and a cap are attached, and empty weight is measured. A total of 0.3 g of sample is loaded into the cell. The filler lot is placed into the cell, and the cap is attached for attachment to a degassing port. Once all the cells to be measured are attached to the degassing port, a helium valve is opened. The button of the port to be degassed is turned on, and a “VAC” button is pressed. Degassing is performed for more than one day.

(Measurement)

The power of the main unit (there is a switch on the back of the main unit) is turned ON. At the same time, the vacuum pump is also started. The power of the main body for circulating water and the operation panel is turned ON. “BEL aqua3.exe” (measurement software) in the center of the PC screen is launched. Temperature control of air hot bath: “SV” in the frame of “TIC1” on the “Flow diagram” window is double clicked to open the “Temperature setting” window. The temperature (80° C.) is input and Settings are clicked.

Adsorption temperature control: “SV” in “Adsorption temperature” in the “Flow diagram” window is double clicked and the “SV value” (adsorption temperature) is input. “Start Circulation” and “External Temperature Control” are clicked and Settings are clicked.

The “PURGE” button is pressed to stop degassing, the port button is turned off, the sample is removed, a cap 2 is attached, the sample is weighed, and then the sample is attached to the main measurement unit. On the PC, “Measurement conditions” is clicked to open the “Measurement conditions setting” window. The measurement conditions are as follows.

Air thermostat temperature: 80.0° C., adsorption temperature: 30.0° C., adsorbate name: H₂O, equilibrium time: 500 sec, temperature wait: 60 min, saturated vapor pressure: 4.245 kPa, sample tube discharge speed: normal, chemical adsorption measurement: none, initial introduction amount: 0.20 cm³ (STP) g⁻1 , number of measurement relative pressure ranges: 4.

The number of samples to be measured is selected, and the “measurement data file name” and “sample weight” are input. The measurement is started.

### (Analysis)

The analysis software is launched and analysis is performed. The moisture adsorption amount at a relative water vapor pressure of 80% is determined.

<Measurement of BET Specific Surface Area of Silica Fine Particles>

The BET specific surface area can be determined by a low-temperature gas adsorption method using a dynamic constant pressure method according to the BET method (BET multipoint method). Using a specific surface area measuring device (trade name: Gemini 2375 Ver.5.0, manufactured by Shimadzu Corporation), the BET specific surface area (m²/g) can be calculated by causing adsorption of nitrogen gas on the sample surface and performing measurement by the BET multipoint method.

From the obtained moisture adsorption amount and BET specific surface area, the moisture adsorption amount per 1 m² of BET specific surface area at a temperature of 30° C. and a relative humidity of 80% is calculated.

A known material can be used as the silica fine particle substrate, which is the silica fine particle before surface treatment. Examples include fumed silica produced by burning a silicon compound, in particular, a silicon halide, generally silicon chloride, and usually purified silicon tetrachloride in an oxyhydrogen flame, wet silica produced from water glass, sol-gel silica particles obtained by a wet method, gel silica particles, aqueous colloidal silica particles, alcoholic silica particles, fused silica particles obtained by a vapor phase method, deflagration silica particles, and the like. Fumed silica is preferred.

The number-average particle size of the silica fine particle 51 is preferably 5.0 nm or more and 500.0 nm or less, more preferably 20.0 nm or more and 300.0 nm or less. Furthermore, 20.0 nm or more and 80.0 nm or less is more preferable. Such ranges of the particle size of the silica fine particle 51 are preferable because the adhesive force between the silica fine particle 51 and the toner particle is more stable.

Also, an external additive other than the silica fine particle 51 may be contained. Silica fine particles other than silica fine particle 51 may be used, and inorganic fine particles other than silica fine particles or organic fine particles such as resin fine particles may be included. When external additives are used in combination and the number average particle diameter of the silica fine particle S1 is denoted by SS1 and the number average particle diameter of the external additive used in combination is denoted by SS2, it is preferable that SS2/SS1 be 1.2 or more. In this case, embedding of the silica fine particle S1 is suppressed even during long-term use or use in a high-temperature environment, so that the charging performance can be further stabilized regardless of the usage environment.

<Number-Average Particle Diameter of Silica Fine Particles S1>

The number average particle diameter of the silica fine particle S1 and silica fine particles S2 can be measured using a Microtrac particle size distribution analyzer HRA (X-100) (manufactured by Nikkiso Co., Ltd.) in a range setting of 0.001 μm to 10 μm.

Binder Resin for Toner Particle

The toner particle comprises a binder resin. A known binder resin can be used in the toner particle. The following are examples of the binder resin:

styrene resins, styrenic copolymer resins, polyester resins, polyol resins, polyvinyl chloride resins, phenolic resins, natural resin-modified phenolic resins, natural resin-modified maleic acid resins, acrylic resins, methacrylic resins, polyvinyl acetate, silicone resins, polyurethane resins, polyamide resins, furan resins, epoxy resins, xylene resins, polyvinyl butyral, terpene resins, coumarone-indene resins, and petroleum resins. Resins preferred for use are styrenic copolymer resins, polyester resins, and hybrid resins provided by mixing a polyester resin with a styrenic copolymer resin or partially reacting the two. The use of polyester resins is preferred.

The components constituting the polyester resin will now be described. A single species or two or more species of the various following components can be used depending on the type and use.

The dibasic carboxylic acid component constituting the polyester resin can be exemplified by the following dicarboxylic acids and their derivatives: benzenedicarboxylic acids and their anhydrides and lower alkyl esters, e.g., phthalic acid, terephthalic acid, isophthalic acid, and phthalic anhydride; alkyl dicarboxylic acids, e.g., succinic acid, adipic acid, sebacic acid, and azelaic acid, and their anhydrides and lower alkyl esters; alkenylsuccinic acids and alkylsuccinic acids having an average value for the number of carbons of from 1 to 50, and their anhydrides and lower alkyl esters; and unsaturated dicarboxylic acids, e.g., fumaric acid, maleic acid, citraconic acid, and itaconic acid, and their anhydrides and lower alkyl esters.

The alkyl group in the lower alkyl esters can be exemplified by the methyl group, ethyl group, propyl group, and isopropyl group.

The dihydric alcohol component constituting the polyester resin, on the other hand, can be exemplified by the following:

ethylene glycol, polyethylene glycol, 1,2-propanediol, 1,3-propanediol, 1,3-butanediol, 1,4-butanediol, 2,3-butanediol, diethylene glycol, triethylene glycol, 1,5-pentanediol, 1,6-hexanediol, neopentyl glycol, 2-methyl-1,3-propanediol, 2-ethyl-1,3-hexanediol, 1,4-cyclohexanedimethanol (CHDM), hydrogenated bisphenol A, bisphenols given by Formula (I-1) and derivatives thereof, and diols given by Formula (I-2).

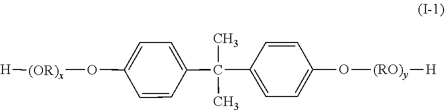

In Formula (I-1), R is the ethylene group or propylene group, x and y are each integers equal to or greater than 0, and the average value of x+y is from 0 to 10.

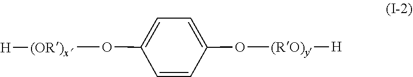

In Formula (I-2), R′ is the ethylene group or propylene group, x′ and y′ are each integers equal to or greater than 0, and the average value of x′ +y′ is from 0 to 10.

In addition to the aforementioned dibasic carboxylic acid component and dihydric alcohol component, the constituent components of the polyester resin may also contain an at least tribasic carboxylic acid component and an at least trihydric alcohol component as constituent.

The at least tribasic carboxylic acid component is not particularly limited and can be exemplified by trimellitic acid, trimellitic anhydride, and pyromellitic acid. The at least trihydric alcohol component can be exemplified by trimethylolpropane, pentaerythritol, and glycerol.

In addition to the aforementioned compounds, the constituent components of the polyester resin may include a monobasic carboxylic acid component and a monohydric alcohol component as constituent components. Specifically, the monobasic carboxylic acid component can be exemplified by palmitic acid, stearic acid, arachidic acid, and behenic acid. Further, cerotic acid, heptacosanoic acid, montanic acid, melissic acid, lacceric acid, tetracontanoic acid, and pentacontanoic acid can be exemplified.

The monohydric alcohol component can be exemplified by behenyl alcohol, ceryl alcohol, melissyl alcohol, and tetracontanol.

The toner may be used in the form of a magnetic single-component toner, a nonmagnetic single-component toner, or a nonmagnetic two-component toner.

When used in the form of a magnetic single-component toner, a magnetic iron oxide particle is preferably used as a colorant. The magnetic iron oxide particle contained in a magnetic single-component toner can be exemplified by magnetic iron oxides such as magnetite, maghemite, and ferrite, and by magnetic iron oxides that contain other metal oxides; as well as by metals such as Fe, Co, and Ni, alloys of these metals with metals such as Al, Co, Cu, Pb, Mg, Ni, Sn, Zn, Sb, Be, Bi, Cd, Ca, Mn, Se, Ti, W, and V, and their mixtures. The content of the magnetic iron oxide particle is preferably from 30 parts by mass to 150 parts by mass relative to 100 parts by mass of the binder resin.

Examples of the colorant are provided below for the case of use in the form of a nonmagnetic single-component toner or a nonmagnetic two-component toner.

Carbon black, e.g., furnace black, channel black, acetylene black, thermal black, and lamp black, may be used as a black pigment, as can a magnetic powder such as magnetite and ferrite.

A pigment or dye may be used as a colorant suitable for the color yellow. The pigments can be exemplified by C. I. Pigment Yellow 1, 2, 3, 4, 5, 6, 7, 10, 11, 12, 13, 14, 15, 17, 23, 62, 65, 73, 74, 81, 83, 93, 94, 95, 97, 98, 109, 110, 111, 117, 120, 127, 128, 129, 137, 138, 139, 147, 151, 154, 155, 167, 168, 173, 174, 176, 180, 181, 183, and 191, and C. I. Vat Yellow 1, 3, and 20. The dyes can be exemplified by C. I. Solvent Yellow 19, 44, 77, 79, 81, 82, 93, 98, 103, 104, 112, and 162. A single one of these may be used by itself or two or more may be used in combination.

A pigment or dye may be used as a colorant suitable for the color cyan. The pigments can be exemplified by C. I. Pigment Blue 1, 7, 15, 15:1, 15:2, 15:3, 15:4, 16, 17, 60, 62, and 66; C. I. Vat Blue 6; and C. I. Acid Blue 45. The dyes can be exemplified by C. I. Solvent Blue 25, 36, 60, 70, 93, and 95. A single one of these may be used by itself or two or more may be used in combination.

A pigment or dye may be used as a colorant suitable for the color magenta. The pigments can be exemplified by C. I. Pigment Red 1, 2, 3, 4, 5, 6, 7, 8, 9, 10, 11, 12, 13, 14, 15, 16, 17, 18, 19, 21, 22, 23, 30, 31, 32, 37, 38, 39, 40, 41, 48, 48:2, 48:3, 48:4, 49, 50, 51, 52, 53, 54, 55, 57, 57:1, 58, 60, 63, 64, 68, 81, 81:1, 83, 87, 88, 89, 90, 112, 114, 122, 123, 144, 146, 150, 163, 166, 169, 177, 184, 185, 202, 206, 207, 209, 220, 221, 238, and 254; C. I. Pigment Violet 19; and C. I. Vat Red 1, 2, 10, 13, 15, 23, 29, and 35.

The magenta dyes can be exemplified by oil-soluble dyes such as C. I. Solvent Red 1, 3, 8, 23, 24, 25, 27, 30, 49, 52, 58, 63, 81, 82, 83, 84, 100, 109, 111, 121, and 122, C. I. Disperse Red 9, C. I. Solvent Violet 8, 13, 14, 21, and 27, and C. I. Disperse Violet 1, and by basic dyes such as C. I. Basic Red 1, 2, 9, 12, 13, 14, 15, 17, 18, 22, 23, 24, 27, 29, 32, 34, 35, 36, 37, 38, 39, and 40, and C. I. Basic Violet 1, 3, 7, 10, 14, 15, 21, 25, 26, 27, and 28. A single one of these may be used by itself or two or more may be used in combination.

The colorant content is preferably from 1 parts by mass to 20 parts by mass relative to 100 parts by mass of the binder resin.

A release agent (wax) may be used in order to provide the toner with releasability.

The wax can be exemplified by the following: aliphatic hydrocarbon waxes such as low molecular weight polyethylene, low molecular weight polypropylene, olefin copolymers, microcrystalline wax, paraffin wax, and Fischer-Tropsch waxes; oxidized waxes of aliphatic hydrocarbon waxes, such as oxidized polyethylene wax; waxes in which the major component is fatty acid ester, such as carnauba wax, behenyl behenate, and montanic acid ester wax; and waxes provided by the partial or complete deoxidization of fatty acid esters, such as deoxidized carnauba wax.

Additional examples are as follows: saturated straight-chain fatty acids such as palmitic acid, stearic acid, and montanic acid; unsaturated fatty acids such as brassidic acid, eleostearic acid, and valinaric acid; saturated alcohols such as stearyl alcohol, aralkyl alcohols, behenyl alcohol, carnaubyl alcohol, ceryl alcohol, and melissyl alcohol; polyhydric alcohols such as sorbitol; fatty acid amides such as linoleamide, oleamide, and lauramide; saturated fatty acid bisamides such as methylenebisstearamide, ethylenebiscapramide, ethylenebislauramide, and hexamethylenebisstearamide; unsaturated fatty acid amides such as ethylenebisoleamide, hexamethylenebisoleamide, N,N′-dioleyladipamide, and N,N 1-dioleylsebacamide; aromatic bisamides such as m-xylenebisstearamide and N,N′-distearylisophthalamide; fatty acid metal salts (generally known as metal soaps) such as calcium stearate, calcium laurate, zinc stearate, and magnesium stearate; waxes provided by grafting an aliphatic hydrocarbon wax using a vinyl comonomer such as styrene or acrylic acid; partial esters between a fatty acid and a polyhydric alcohol, such as behenyl monoglyceride; and hydroxy group-containing methyl ester compounds obtained by, e.g., the hydrogenation of plant oils.

Aliphatic hydrocarbon waxes are waxes particularly preferred for use. Preferred examples are low molecular weight hydrocarbons provided by the high-pressure radical polymerization of alkylene or by the low-pressure polymerization of alkylene in the presence of a Ziegler catalyst or metallocene catalyst; Fischer-Tropsch waxes synthesized from coal or natural gas; paraffin waxes; olefin polymers obtained by the pyrolysis of high molecular weight olefin polymers; and synthetic hydrocarbon waxes obtained from the distillation residue of hydrocarbon obtained by the Arge method from synthesis gas containing carbon monoxide and hydrogen, as well as the synthetic hydrocarbon waxes provided by the hydrogenation of such synthetic hydrocarbon waxes.

The use is more preferred of waxes obtained by subjecting a hydrocarbon wax to fractionation by a press sweating method, solvent method, use of vacuum distillation, or fractional crystallization. Among the paraffin waxes, Fischer-Tropsch waxes and n-paraffin waxes in which the straight-chain component predominates are particularly preferred from the standpoint of the molecular weight distribution.

A single one of these waxes may be used by itself or two or more may be used in combination. The wax is preferably added at from 1 parts by mass to 20 parts by mass relative to 100 parts by mass of the binder resin.

A charge control agent may be used in the toner. Known charge control agents may be used as this charge control agent. Examples here are azo iron compounds, azo chromium compounds, azo manganese compounds, azo cobalt compounds, azo zirconium compounds, chromium compounds of carboxylic acid derivatives, zinc compounds of carboxylic acid derivatives, aluminum compounds of carboxylic acid derivatives, and zirconium compounds of carboxylic acid derivatives.

Aromatic hydroxycarboxylic acids are preferred for the aforementioned carboxylic acid derivative. A charge control resin may also be used. As necessary, a single species of charge control agent may be used or two or more species of charge control agents may be used in combination. The charge control agent is preferably added at from 0.1 parts by mass to 10 parts by mass relative to 100 parts by mass of the binder resin.

The toner and the magnetic carrier may be mixed and used as a two-component developer.

The magnetic carrier consists of magnetic carrier core particles and a resin coating layer that coats (covers) the surface of the magnetic carrier core particles. The resin coating layer does not necessarily have to coat the entire surface of the magnetic carrier core particles, and there may be places where the magnetic carrier core particles are partially exposed.

Usual magnetic carrier core particles such as ferrite and magnetite, and resin-coated carriers can be used as the magnetic carrier core particles. In addition, magnetic body-dispersed resin particles in which magnetic body powder is dispersed in a resin component, or porous magnetic core particles containing a resin in voids can be used.

Various magnetic iron compound particle powders such as magnetite particle powder, maghemite particle powder, and magnetic iron oxide particle powders obtained by including at least one selected from silicon oxide, silicon hydroxide, aluminum oxide, and aluminum hydroxide into magnetite particle powder and maghemite particle powder; magnetoplumbite-type ferrite particle powder containing barium, strontium or barium-strontium; spinel-type ferrite particle powder containing at least one selected from manganese, nickel, zinc, lithium and magnesium; and the like can be used as the magnetic body component to be used in the magnetic body-dispersed resin particles.

In addition to the magnetic body component, non-magnetic iron oxide particle powder such as hematite particle powder, non-magnetic hydrous ferric oxide particle powder such as goethite particle powder, and non-magnetic inorganic compound particle powder such as titanium oxide particle powder, silica particle powder, talc particle powder, alumina particle powder, barium sulfate particle powder, barium carbonate particle powder, cadmium yellow particle powder, calcium carbonate particle powder, zinc oxide particle powder, and the like may be used in combination with the magnetic iron compound particle powder.

Examples of material for the porous magnetic core particles include magnetite and ferrite. A specific example of ferrite is represented by the following general formula.

(M1₂O)ₓ(M2O)_{y}(Fe₂O₃)_{z}

In the above formula, M1 is a monovalent metal, M2 is a divalent metal, and when x+y+z=1.0, x and y are 0≤(x, y)≤0.8, and z is 0.2<z<1.0)

In the formula, it is preferable to use at least one metal atom selected from the group consisting of Li, Fe, Mn, Mg, Sr, Cu, Zn and Ca as M1 and M2. In addition, Ni, Co, Ba, Y, V, Bi, In, Ta, Zr, B, Mo, Na, Sn, Ti, Cr, Al, Si, rare earth elements, and the like can also be used.

The magnetic carrier core particle is preferably a porous magnetic core particle containing a resin in the voids.

Either a thermoplastic resin or a thermosetting resin may be used as the resin to fill the voids of the porous magnetic core particle.

Examples of thermoplastic resins suitable as the filling resin include the following. Novolak resins, saturated alkyl polyester resins, polyarylates, polyamide resins, acrylic resins, and the like.

Examples of thermosetting resins include the following. Phenolic resins, epoxy resins, unsaturated polyester resins, silicone resins, and the like.

The magnetic carrier comprises magnetic a carrier core particle and a resin coating layer that coats (covers) the surface of the magnetic carrier core particles.

The method of coating the surface of the magnetic carrier core particles with the resin is not particularly limited, and coating can be performed by coating methods such as dipping, spraying, brushing, and fluidized bed coating. Among them, the dipping method is preferable.

The amount of the resin coating the surface of the magnetic carrier core particles (the amount of the resin coating layer) of 0.1 parts by mass or more and 5.0 parts by mass or less with respect to 100 parts by mass of the magnetic carrier core particles is preferable for controlling the charge-providing performance for the toner.

Examples of the resin suitable for the resin coating layer include acrylic resins such as acrylic acid ester copolymers, methacrylic acid ester copolymers, and the like; styrene-acrylic resins such as styrene-acrylic resin ester copolymers, styrene-methacrylic acid ester copolymers, and the like; fluorine-containing resins such as polytetrafluoroethylene, tetrafluoroethylene-hexafluoropropylene copolymer, monochlorotrifluoroethylene polymer, polyvinylidene fluoride, and the like; silicone resins, polyester resins, polyamide resins, polyvinyl butyral, amino acrylate resins, ionomer resins, polyphenylene sulfide resins, and the like. These resins can be used singly or in combination.

Among these, a copolymer synthesized using a (meth)acrylic acid ester monomer having an alicyclic hydrocarbon group is particularly preferable from the viewpoint of charging stability. The resin used for the resin coating layer preferably contains a monomer unit of a (meth)acrylic acid ester having an alicyclic hydrocarbon group.

Examples of (meth)acrylic acid esters having an alicyclic hydrocarbon group include cyclobutyl acrylate, cyclopentyl acrylate, cyclohexyl acrylate, cycloheptyl acrylate, dicyclopentenyl acrylate, dicyclopentanyl acrylate, cyclobutyl methacrylate, cyclopentyl methacrylate, cyclohexyl methacrylate, cycloheptyl methacrylate, dicyclopentenyl methacrylate, dicyclopentanyl methacrylate, and the like.

The alicyclic hydrocarbon group is preferably a cycloalkyl group, and preferably has 3 to 10 carbon atoms, more preferably 4 to 8 carbon atoms. One or two or more of these may be selected and used.

In the copolymer used for the resin coating layer, the content ratio of the monomer unit (copolymerization ratio based on mass) of the methacrylic acid ester having an alicyclic hydrocarbon group is preferably 5.0% by mass or more and 80.0% by mass or less. Within the above range, the charging performance in a high-temperature and high-humidity environment is good.

Furthermore, from the viewpoint of charging stability and also from the viewpoint of increasing the adhesiveness between the magnetic carrier core particle and the resin coating layer and suppressing local peeling of the resin coating layer, it is more preferable that the resin in the resin coating layer include a macromonomer as a copolymer component.

The macromonomer is preferably a macromonomer having a polymer portion of at least one monomer selected from the group consisting of methyl acrylate, methyl methacrylate, butyl acrylate, butyl methacrylate, 2-ethylhexyl acrylate, and 2-ethylhexyl methacrylate.

An example of a specific macromonomer is shown in formula (B). That is, it is preferable that the resin in the resin coating layer have a monomer unit corresponding to a macromonomer represented by the following formula (B).

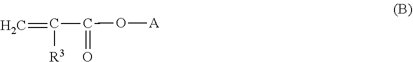

In formula (B), A represents a polymer of at least one compound selected from the group consisting of methyl acrylate, methyl methacrylate, butyl acrylate, butyl methacrylate, 2-ethylhexyl acrylate, 2-ethylhexyl methacrylate, styrene, acrylonitrile and methacrylonitrile. R³ is H or CH³.

A is preferably a polymer of methyl methacrylate.

In order to improve the adhesion between the magnetic carrier core particle and the resin coating layer, the weight-average molecular weight of the macromonomer is preferably 3000 or more and 10,000 or less, more preferably 4000 or more and 7000 or less.

In order to improve the adhesion between the magnetic carrier core particle and the resin coating layer, the content ratio of the monomer unit of the macromonomer in the resin used for the resin coating layer (copolymerization ratio based on the mass of the macromonomer) is preferably 0.5% by mass or more and 30.0% by mass or less. Measurement of the Weight-Average Molecular Weight of the Macromonomer

The weight-average molecular weight is measured using gel permeation chromatography (GPC) and using the following procedure.

The measurement sample is first prepared as follows.

A sample (the coating resin is separated from the magnetic carrier and is fractionated with a fractionator to give the sample) is mixed at a concentration of 5 mg/mL with tetrahydrofuran (THF), and the sample is dissolved in the THF by standing for 24 hours at room temperature. This is followed by filtration across a sample treatment filter (Sample Pretreatment Cartridge H-25-2, Tosoh Corporation) to provide the GPC sample.

The measurement is then run using a GPC measurement instrument (HLC-8120GPC, Tosoh Corporation) in accordance with the operating manual provided with the instrument and using the following measurement conditions.

### Measurement Conditions

Instrument: “HLC8120 GPC” high-performance GPC (Tosoh Corporation)
Column: 7-column train of Shodex KF-801, 802, 803, 804, 805, 806, and 807 (Showa Denko Kabushiki Kaisha)

### Eluent: THF

Flow rate: 1.0 mL/min
Oven temperature: 40.0° C.
Amount of sample injection: 0.10 mL

For the calibration curve, a molecular weight calibration curve constructed using polystyrene resin standards (Tosoh Corporation, TSK Standard Polystyrene F-850, F-450, F-288, F-128, F-80, F-40, F-20, F-10, F-4, F-2, F-1, A-5000, A-2500, A-1000, A-500) is used to determine the weight-average molecular weight of the sample.

The toner comprises a toner particle and a silica fine particle S1 on a surface of the toner particle. That is, the toner comprises a silica fine particle S1 as an external additive.

The amount of the silica fine particle S1 externally added to the toner particle is preferably 0.01 parts by mass or more and 10.00 parts by mass or less, preferably 1.0 part by mass or more and 10.00 parts by mass or less relative to 100 parts by mass of the toner particles. More preferably, this amount is 1.0 part by mass or more and 5.00 parts by mass or less. As a result, the silica fine particles can appropriately cover the toner particle, the effects of the present invention are exhibited more effectively, the charging stability is improved, and even when the environment changes, fluctuations in image density are small and changes in image density during continuous printing can be suppressed.

External addition of an external additive such as silica fine particles to the toner particles can be carried out by mixing the toner particles and the external additive with the following mixers.

Examples of mixers include the following. Henschel mixer (manufactured by Mitsui Mining Co., Ltd.), SUPER MIXER (manufactured by Kawata Corporation), RIBOCONE (manufactured by Okawara Mfg. Co., Ltd.), NAUTA MIXER, TURBULIZER, CYCLOMIX (manufactured by Hosokawa Micron Corporation), SPIRAL PIN MIXER (manufactured by Pacific Machinery & Engineering Co., Inc.), and Lodige mixer (manufactured by Matsubo Corporation).

The toner particles are preferably surface-treated with hot air. Furthermore, it is preferable to perform the surface treatment with hot air after the silica fine particle S1 has been attached to the toner particle surface before the surface treatment with hot air. This is preferable because in such case the silica fine particle S1 does not move on the toner particle surface even in long-term use, and the charging performance is stabilized.

For example, a method for producing the toner preferably has:

a step of obtaining a toner particle;
a step of preparing a silica fine particle S1;
a step of externally adding some of the silica fine particle S1 to the obtained toner particle and mixing;
a step of heat-treating the toner particle externally added and mixed with the silica fine particle; and
a step of externally adding remaining silica fine particle S1 to the heat-treated toner particle and mixing to obtain a toner.

In the external addition step before the heat treatment, it is preferable to externally add and mix 65% by mass to 85% by mass of the silica fine particle S1. In the external addition to the heat-treated toner particles and mixing, it is preferable to externally add and mix 15% by mass to 35% by mass of the silica fine particle S1.

A specific example of a method for surface-treating toner particles (for example, toner particles to which silica fine particles have been externally added and mixed) with hot air using the heat treatment apparatus shown in the Figure will be described below. In the example, toner particles are referred to as a material to be processed.

The material to be processed, which has been quantitatively supplied by a raw material metered supply means 1, is guided to an introduction pipe 3 installed on the vertical line of the raw material supply means by a compressed gas adjusted by a compressed gas flow rate adjusting means 2. The material to be processed that has passed through the introduction pipe 3 is uniformly dispersed by a conical protruding member 4 provided in the central portion of the raw material supply means and is guided to supply pipes 5, which extend radially in eight directions, and guided to a processing chamber 6 where heat treatment is performed.

At this time, the flow of the material to be processed supplied to the processing chamber 6 is regulated by a regulating means 9 provided in the processing chamber 6 for regulating the flow of the material to be processed. Therefore, the material to be processed that is supplied to the processing chamber 6 is heat-treated while swirling in the processing chamber 6, followed by cooling.

Hot air for heat-treating the supplied material to be processed is supplied from a hot air supply means 7, distributed by a distribution member 12, and introduced while being spirally swirled in the processing chamber 6 by a swirling member 13 for swirling the hot air. The swirling member 13 for swirling the hot air is configured to have a plurality of blades, and the swirling of the hot air can be controlled by the number and angles of the blades (11 is the outlet of the hot air supply means).

The hot air supplied into the processing chamber 6 preferably has a temperature of at least 100° C. and not more than 300° C., more preferably at least 130° C. and not more than 190° C., at the outlet of the hot air supply means 7. Where the temperature at the outlet of the hot air supply means 7 is within the above ranges, it is possible to adjust the embedment of the silica fine particles while preventing fusion or coalescence of the material to be processed due to overheating. Hot air is supplied from the hot air supply means 7.

Further, the heat-treated resin particles that have been heat-treated are cooled by cold air supplied from a cold air supply means 8. The temperature of the cold air supplied from the cold air supply means 8 is preferably at least −20° C. and not more than 30° C. Where the temperature of the cold air is within the above range, the heat-treated material to be processed can be efficiently cooled, and it is thought that fusion and coalescence of the material to be processed are unlikely to occur. Also, the absolute moisture content of the cool air is preferably at least 0.5 g/m³ and not more than 15.0g/m³.

Next, the cooled material to be processed is collected by a collecting means 10 located at the lower end of the processing chamber 6. A blower (not shown) is provided at the end of the collecting means 10, and suction and conveying are performed by the blower.

A powder particle supply port 14 is provided so that the swirling direction of the supplied material to be processed and the swirling direction of the hot air are the same, and the collecting means 10 is also provided tangentially on the outer periphery of the processing chamber 6 so as to maintain the swirling direction of the swirling material to be processed. Furthermore, the configuration is such that the cold air supplied from the cold air supply means 8 is supplied horizontally and tangentially from the outer peripheral portion of the apparatus to the inner peripheral surface of the processing chamber.

The swirling direction of the material to be processed supplied from the powder particle supply port 14, the swirling direction of the cold air supplied from the cold air supply means 8, and the swirling direction of the hot air supplied from the hot air supply means 7 are all the same. As a result, no turbulent flow occurs in the processing chamber, the swirling flow in the apparatus is strengthened, and a strong centrifugal force is applied to the material to be processed before the heat treatment, further improving dispersibility, so that toner particles with only few coalesced particles are easily obtained.

In the step of obtaining toner particles, a method for producing toner particles is not particularly limited, and the production can be performed by a known method. Examples thereof include a pulverization method, an emulsion aggregation method, a suspension polymerization method, a dissolution suspension method, and the like.

The toner particles produced by the pulverization method are produced, for example, in the following manner.

A binder resin, a colorant and, if necessary, other additives are thoroughly mixed using a mixer such as a Henschel mixer or a ball mill. The mixture is melt-kneaded using a hot kneader such as a twin-screw kneading extruder, heated rolls, a kneader, or an extruder. At that time, wax, magnetic iron oxide particles and metal-containing compounds can also be added.

After cooling and solidifying the melt-kneaded product, it is pulverized and classified to obtain toner particles. At this time, by adjusting the exhaust temperature during pulverization, it is possible to control the embedment of the silica fine particles in the toner particle surface. A toner can be obtained by mixing toner particles and a silica external additive with a mixer such as a Henschel mixer.

The mixer can be exemplified by the following: Henschel mixer (Mitsui Mining Co., Ltd.); Supermixer (Kawata Mfg. Co., Ltd.); Ribocone (Okawara Corporation); Nauta mixer, Turbulizer, and Cyclomix (Hosokawa Micron Corporation); Spiral Pin Mixer (Pacific Machinery & Engineering Co., Ltd.); and Loedige Mixer (Matsubo Corporation).

The kneader can be exemplified by the following: KRC Kneader (Kurimoto, Ltd.); Buss Ko-Kneader (Buss Corp.); TEM extruder (Toshiba Machine Co., Ltd.); TEX twin-screw kneader (The Japan Steel Works, Ltd.); PCM Kneader (Ikegai Ironworks Corporation); three-roll mills, mixing roll mills, and kneaders (Inoue Manufacturing Co., Ltd.); Kneadex (Mitsui Mining Co., Ltd.); Model MS pressure kneader and Kneader-Ruder (Moriyama Mfg. Co., Ltd.); and Banbury mixer (Kobe Steel, Ltd.).

The pulverizer can be exemplified by the following: Counter Jet Mill, Micron Jet, and Inomizer (Hosokawa Micron Corporation); IDS mill and PJM Jet Mill (Nippon Pneumatic Mfg. Co., Ltd.); Cross Jet Mill (Kurimoto, Ltd.); Ulmax (Nisso Engineering Co., Ltd.); SK Jet-O-Mill (Seishin Enterprise Co., Ltd.); Kryptron (Kawasaki Heavy Industries, Ltd.); Turbo Mill (Turbo Kogyo Co., Ltd.); and Super Rotor (Nisshin Engineering Inc.).

As necessary, pulverization may also be followed by the execution of a surface treatment on the toner particle to control embedding of the silica fine particles on a surface of a toner particle using a Hybridization System (Nara Machinery Co., Ltd.), Nobilta (Hosokawa Micron Corporation), Mechanofusion System (Hosokawa Micron Corporation), Faculty (Hosokawa Micron Corporation), Inomizer (Hosokawa Micron Corporation), Theta Composer (Tokuju Corporation), Mechanomill (Okada Seiko Co., Ltd.), or Meteo Rainbow MR Type (Nippon Pneumatic Mfg. Co., Ltd.).

The classifier can be exemplified by the following: Classiel, Micron Classifier, and Spedic Classifier (Seishin Enterprise Co., Ltd.); Turbo Classifier (Nisshin Engineering Inc.); Micron Separator, Turboplex (ATP), and TSP Separator (Hosokawa Micron Corporation); Elbow Jet (Nittetsu Mining Co., Ltd.); Dispersion Separator (Nippon Pneumatic Mfg. Co., Ltd.); and YM Microcut (Yasukawa Shoji Co., Ltd.).

Screening devices that can be used to screen out the coarse particles can be exemplified by the following: Ultrasonic (Koei Sangyo Co., Ltd.), Rezona Sieve and Gyro-Sifter (Tokuju Corporation), Vibrasonic System (Dalton Co., Ltd.), Soniclean (Sintokogio, Ltd.), Turbo Screener (Turbo Kogyo Co., Ltd.), Microsifter (Makino Mfg. Co., Ltd.), and circular vibrating sieves.

A produced toner particle may be produced by the emulsion aggregation method, for example, proceeding as follows.

### Step of Preparing a Resin Fine Particle Dispersion (Preparation Step)

For example, a uniform solution is formed by dissolving a polyester resin or a styrene acrylic resin as a binder resin component in an organic solvent. This is followed on an optional basis by the addition of a basic compound and/or a surfactant. Resin fine particles of the binder resin are formed by the gradual addition of an aqueous medium to this solution while applying shear force to the solution using, for example, a homogenizer. The organic solvent is finally removed to produce a resin fine particle dispersion in which resin fine particles are dispersed.

During the preparation of the resin fine particle dispersion, the amount of addition of the resin component that is dissolved in the organic solvent, expressed relative to 100 parts by mass of the organic solvent, is preferably from 10 parts by mass to 50 parts by mass and more preferably from 30 parts by mass to 50 parts by mass.

Any organic solvent capable of dissolving the resin component may be used, but solvents exhibiting a high solubility for olefin resins, e.g., toluene, xylene, ethyl acetate, and so forth, are preferred.

There are no particular limitations on the surfactant. The following are examples: anionic surfactants such as the salts of sulfate esters, sulfonate salts, carboxylate salts, phosphate esters, and soaps; cationic surfactants such as amine salts and quaternary ammonium salts; and nonionic surfactants such as polyethylene glycols, ethylene oxide adducts on alkylphenols, and polyhydric alcohol systems.

The basic compound can be exemplified by inorganic bases such as sodium hydroxide and potassium hydroxide and by organic bases such as triethylamine, trimethylamine, dimethylaminoethanol, and diethylaminoethanol. A single species of basic compound may be used by itself or two or more species may be used in combination.

Aggregation Step

The aggregation step is a step of forming aggregate particles by preparing a mixture by mixing, as necessary, a colorant fine particle dispersion, wax fine particle dispersion, and silicone oil emulsion into the resin fine particle dispersion and then aggregating the fine particles present in the thusly prepared mixture.

A favorable example of the method for forming the aggregate particles is a method in which an aggregating agent is added to and mixed with the mixture and the temperature is raised and/or, e.g., mechanical energy is suitably applied.

The colorant fine particle dispersion is prepared by the dispersion of a colorant. The colorant fine particles are dispersed using a known method, but the use is preferred of, for example, a rotary shear homogenizer; a media-based disperser such as a ball mill, sand mill, or attritor; or a high-pressure countercollision disperser. A surfactant or polymeric dispersing agent that imparts dispersion stability can also be added on an optional basis.

The wax fine particle dispersion and the silicone oil emulsion are prepared by dispersing the respective materials in an aqueous medium. The respective materials may be dispersed using a known method, but the use is preferred of, for example, a rotary shear homogenizer; a media-based disperser such as a ball mill, sand mill, or attritor; or a high-pressure countercollision disperser. A surfactant or polymeric dispersing agent that imparts dispersion stability can also be added on an optional basis.

The aggregating agent can be exemplified by the metal salts of monovalent metals such as sodium, potassium, and so forth; metal salts of divalent metals such as calcium, magnesium, and so forth; metal salts of trivalent metals such as iron, aluminum, and so forth; and polyvalent metal salts such as polyaluminum chloride. Viewed from the standpoint of the ability to control the particle diameter in the aggregation step, metal salts of divalent metals, e.g., calcium chloride, magnesium sulfate, and so forth, are preferred.

The addition and mixing of the aggregating agent is preferably carried out in the temperature range from room temperature to 75° C. When mixing is performed using this temperature condition, it proceeds in a state in which the aggregation is stable. Mixing can be carried out using, for example, a known mixing apparatus, homogenizer, or mixer.

Fusion Step

The fusion step is a step in which the aggregate particle is fused or coalesced, preferably by heating to at least the melting point of the olefin resin, to produce a particle in which the surface of the aggregate particle has been smoothened.

Prior to the fusion step, for example, a chelating agent, pH regulator, surfactant, and so forth may be introduced as appropriate in order to prevent the obtained resin particles from melt-adhering to each other.

The chelating agent can be exemplified by ethylenediaminetetraacetic acid (EDTA) and its alkali metal salts, for example, its Na salt; sodium gluconate; sodium tartrate; potassium citrate and sodium citrate; nitrilotriacetate (NTA) salts; and highly water-soluble polymers that contain both the COOH and OH functionalities (polyelectrolytes).

With regard to the duration of the fusion step, shorter times will suffice at higher heating temperatures while longer times will be required at lower heating temperatures. Thus, the duration of heating/fusion cannot be unconditionally specified because it depends on the heating temperature; however, it will generally be about from 10 minutes to 10 hours.

Cooling Step

This is a step of cooling the temperature of the resin particle-containing aqueous medium obtained in the fusion step. While not a particular limitation, a specific cooling rate is about 0.1 to 50° C./minute.

Washing Step

The impurities in the resin particle can be removed by subjecting the resin particles produced via the preceding steps to repeated washing and filtration.

Specifically, preferably the resin particle is washed using an aqueous solution containing a chelating agent, e.g., ethylenediaminetetraacetic acid (EDTA) or its sodium salt, and additionally washed with pure water.

The metal salt, surfactant, and so forth in the resin particle can be removed by repeating the pure water wash+filtration a plurality of times. Filtration is performed preferably from 3 to 20 times from the standpoint of the production efficiency, with 3 to 10 times being more preferred.

Drying and Classification Step

The toner particle can be obtained by drying the washed resin particle and carrying out classification as appropriate.

Step of Adding External Additive to Toner Particle

The toner can be obtained by mixing the toner particle and an external additive by mixer such as a Henschel mixter.

A toner particle produced by the dissolution suspension method may be produced, for example, proceeding as follows.

In the dissolution suspension method, a resin composition is obtained by dissolving the binder resin component in an organic solvent; this resin composition is dispersed in an aqueous medium to granulate the resin composition into particles; and the organic solvent present in the resin composition particles is removed to produce a toner particle.

The dissolution suspension method is adaptable as long as the resin component can dissolve in an organic solvent, and in addition provides for easy shape control as a function of the conditions in solvent removal.

A toner production method using the dissolution suspension method is specifically described in the following, but there is no limitation to this.

Resin Component Dissolution Step

In the resin component dissolution step, the binder resin and as necessary other components, e.g., colorant, wax, silicone oil, and so forth, are dissolved or dispersed in an organic solvent to prepare a resin composition.

Any solvent that is an organic solvent that can dissolve the resin component can be used as the organic solvent used here. Specific examples are toluene, xylene, chloroform, methylene chloride, and ethyl acetate. The use of toluene and ethyl acetate is preferred for the ease of solvent removal and promotion of crystallization of crystalline resin.

The amount of use of the organic solvent is not limited, but should be an amount that provides a viscosity that enables the resin composition to disperse and granulate in a poor solvent, e.g., water. Specifically, the mass ratio between the resin component and optional other components, e.g., colorant, wax, and silicone oil, and the organic solvent is preferably 10/90 to 50/50 from the standpoints of the granulatability, infra, and the toner particle production efficiency.

On the other hand, the colorant, wax, and silicone oil need not undergo dissolution in the organic solvent and may undergo dispersion. When the colorant, wax, and silicone oil are employed in a dispersed condition, dispersion is preferably performed using a disperser such as a bead mill.

Granulation Step

The granulation step is a step of producing particles of the obtained resin composition by dispersing the resin composition in an aqueous medium using a dispersing agent so as to provide a prescribed toner particle diameter.

Water is mainly used as the aqueous medium. In addition, this aqueous medium preferably contains from 1 mass % to 30 mass % of a monovalent metal salt. The incorporation of the monovalent metal salt serves to suppress diffusion of the organic solvent in the resin composition into the aqueous medium and to increase the crystallinity of the resin component present in the resulting toner particle.

This facilitates the appearance of an excellent antiblocking behavior by the toner and facilitates the appearance of an excellent particle size distribution for the toner.

The monovalent metal salt can be exemplified by sodium chloride, potassium chloride, lithium chloride, and potassium bromide, whereamong sodium chloride and potassium chloride are preferred.

In addition, the mixing ratio (mass ratio) between the aqueous medium and resin composition is preferably aqueous medium/resin composition=90/10 to 50/50.

There are no particular limitations on the dispersing agent, and a cationic, anionic, or nonionic surfactant is used as an organic dispersing agent, wherein anionic surfactants are preferred.

Examples here sodium alkylbenzenesulfonate, sodium α-olefinsulfonate, sodium alkylsulfonate, and sodium alkyl diphenyl ether disulfonate. Inorganic dispersing agents, on the other hand, can be exemplified by tricalcium phosphate, hydroxyapatite, calcium carbonate fine particles, titanium oxide fine particles, and silica fine particles.

The inorganic dispersing agent tricalcium phosphate is preferred among the preceding. The reasons for this are its granulation performance and stability and because it has very little negative effect on the properties of the resulting toner.

The amount of addition of the dispersing agent is determined in conformity to the particle diameter of the granulate, and larger amounts of dispersing agent addition provide smaller particle diameters. Due to this, the amount of addition for the dispersing agent will vary depending on the desired particle diameter, but use in the range of 0.1 to 15 mass % with reference to the resin composition is preferred.

The production of the resin composition particles in the aqueous medium is preferably carried out under the application of high-speed shear. Devices that apply high-speed shear can be exemplified by various high-speed dispersers and ultrasound dispersers.

Solvent Removal Step

In the solvent removal step, the organic solvent contained in the resulting resin composition particle is removed to produce a toner particle. This organic solvent removal may be performed while stirring.

Washing, Drying, and Classification Step

After the solvent removal step, a washing and drying step may be executed in which washing is performed a plurality of times with, e.g., water, and the toner particle is then filtered off and dried. When a dispersing agent that dissolves under acidic conditions, e.g., tricalcium phosphate, has been used as the dispersing agent, preferably washing with, e.g., hydrochloric acid, is carried out followed by washing with water. The execution of washing can remove the dispersing agent used for granulation. The toner particle can be obtained by following washing with filtration, drying, and classification as appropriate.

Step of Adding External Additive to Toner Particle

The toner can be obtained by mixing the toner particle and an external additive by mixer such as a Henschel mixter.

Toner particles produced by a suspension polymerization method are produced, for example, in the following manner.

A polymerizable monomer composition is prepared by uniformly dissolving or dispersing a polymerizable monomer, a colorant, a wax component, a polymerization initiator, and the like by using a dispersing machine such as a homogenizer, a ball mill, an ultrasonic disperser, and the like. After dispersing the polymerizable monomer composition in an aqueous medium to granulate particles of the polymerizable monomer composition, the polymerizable monomer in the particles of the polymerizable monomer composition is polymerized to obtain toner particles.

At this time, the polymerizable monomer composition is preferably prepared by mixing a dispersion liquid obtained by dispersing a colorant in a first polymerizable monomer (or a part of the polymerizable monomer), and at least a second polymerizable monomer (or the rest of the polymerizable monomer). That is, by sufficiently dispersing the colorant in the first polymerizable monomer and then mixing with other toner materials together with the second polymerizable monomer, a better dispersion state of the colorant in the polymer particles can be obtained.

Toner particles are obtained by filtering, washing, drying and classifying the obtained polymer particles by a known method. A toner can be obtained by mixing the obtained toner particles and an external additive with a mixer such as a Henschel mixer.

The weight-average particle diameter (D4) of the toner is 4.0 μm or more and 15.0 μm or less, preferably 4.0 μm or more and 9.0 μm or less. As a result, the silica fine particle S1 can appropriately cover the toner particle. In addition, the contact area between the silica fine particle S1 and the toner particle is optimized, the effect of the present invention is exhibited more effectively, charging stability is improved, image density fluctuations are small even when the environment changes, and changes in image density during continuous printing can be suppressed. Method for Measuring Weight-Average Particle Diameter (D4) of Toner

The weight-average particle diameter (D4) of the toner is calculated by using a precision particle diameter distribution measuring device “Coulter Counter Multisizer 3” (registered trademark, manufactured by Beckman Coulter, Inc.), which is based on a pore electrical resistance method and equipped with a 100 μm aperture tube, and dedicated software “Beckman Coulter Multisizer 3 Version 3.51” (manufactured by Beckman Coulter, Inc.) provided therewith for setting measurement conditions and analyzing the measurement data, performing measurements at the number of effective measurement channels of 25,000 and analyzing the measurement data.

For the electrolytic aqueous solution used for measurement, a solution in which special grade sodium chloride is dissolved in ion-exchanged water so that the concentration is about 1% by mass, for example, “ISOTON II” (manufactured by Beckman Coulter, Inc.) can be used.

Before performing the measurement and analysis, the dedicated software is set as follows.

At the “Change Standard Measurement Method (SOM) Screen” of the dedicated software, the total number of counts in control mode is set to 50,000 particles, the number of measurements is set to 1, and a value obtained using “Standard Particle 10.0 μm” (manufactured by Beckman Coulter Co., Ltd.) is set as the Kd value. The threshold and noise level are automatically set by pressing the threshold/noise level measurement button. Also, the current is set to 1600 μA, the gain is set to 2, the electrolytic solution is set to ISOTON II, and the flash of aperture tube after measurement is checked.

At the “Pulse to Particle Diameter Conversion Setting Screen” of the dedicated software, the bin interval is set to logarithmic particle diameter, the particle diameter bin is set to a 256 particle diameter bin, and the particle diameter range is set to from 2 μm to 60 μm.

The specific measurement method is as follows.

(1) About 200 ml of the electrolytic aqueous solution is placed in a 250 ml round-bottom glass beaker exclusively provided for Multisizer 3, the beaker is set on a sample stand, and a stirrer rod is stirred counterclockwise at 24 revolutions/second. Then, the dirt and air bubbles inside the aperture tube are removed using the “Flush Aperture Tube” function of the dedicated software.

(2) About 30 ml of the electrolytic aqueous solution is placed in a 100 ml flat-bottomed glass beaker, and about 0.3 ml of a diluent obtained by 3-fold by mass dilution of “CONTAMINON N” (a 10% by mass aqueous solution of a neutral detergent for washing precision measuring instruments at pH 7, which consists of a nonionic surfactant, an anionic surfactant, and an organic builder, manufactured by Wako Pure Chemical Industries, Ltd.) as a dispersing agent with ion-exchanged water is added thereto.

(3) A predetermined amount of ion-exchanged water is placed in a water tank of an ultrasonic disperser “Ultrasonic Dispersion System Tetora 150” (manufactured by Nikkaki Bios Co., Ltd.) having an electrical output of 120 W and containing two oscillators with an oscillation frequency of 50 kHz that are built in with a phase shift of 180 degrees, and about 2 ml of the CONTAMINON N is added to the water tank.

(4) The beaker of (2) is set in the beaker fixing hole of the ultrasonic disperser and the ultrasonic disperser is operated. The height position of the beaker is adjusted so that the resonance state of the liquid level of the electrolytic aqueous solution in the beaker is maximized.

(5) While the electrolytic aqueous solution in the beaker in (4) above is being irradiated with ultrasonic waves, about 10 mg of toner is added little by little to the electrolytic aqueous solution and dispersed. Then, the ultrasonic dispersion treatment is continued for another 60 sec. In the ultrasonic dispersion, the temperature of water in the water tank is appropriately adjusted to from 10° C. to 40° C.

(6) The electrolytic aqueous solution of (5) in which the toner is dispersed is dropped using a pipette into the round-bottomed beaker of (1) installed in the sample stand, and the measured concentration is adjusted to about 5%. The measurement is continued until the number of measured particles reaches 50,000.

(7) The measurement data are analyzed with the dedicated software provided with the device, and the weight-average particle diameter (D4) is calculated. The weight-average particle diameter (D4) is the “average diameter” on the analysis/volume statistics (arithmetic mean) screen when graph/vol% is set using the dedicated software.

### EXAMPLES

The basic constitution and features of the present invention are described in the preceding, while the present invention is specifically described in the following based on examples. However, the present invention is in no way limited thereby. Unless specifically indicated otherwise, parts and % are on a mass basis.

<Production Example of Binder Resin 1>
Bisphenol A ethylene oxide (2.2 mol adduct): 50.0 mol parts
Bisphenol A propylene oxide (2.2 mol adduct): 50.0 mol parts
Terephthalic acid: 90.0 mol parts
Trimellitic anhydride: 10.0 mol parts

A total of 100 parts by mass of the monomers constituting the polyester unit were mixed with 500 ppm of titanium tetrabutoxide in a 5-liter autoclave.

A reflux condenser, a water separator, an N₂ gas introduction pipe, a thermometer and a stirrer were attached to the autoclave, and the polycondensation reaction was carried out at 230° C. while introducing N₂ gas into the autoclave. The reaction time was adjusted so as to obtain a desired softening point. After completion of polymerization, the resin was taken out of the container, cooled and pulverized to obtain a binder resin 1. The binder resin 1 had a softening point of 130° C. and a Tg of 57° C.

The softening point was measured in the following manner.

Measurement of the Softening Point

The softening point is measured using a “Flowtester CFT-500D Flow Property Evaluation Instrument” (Shimadzu Corporation), which is a constant-load extrusion-type capillary rheometer, in accordance with the manual provided with the instrument. With this instrument, while a constant load is applied by a piston from the top of the measurement sample, the measurement sample filled in a cylinder is heated and melted and the melted measurement sample is extruded from a die at the bottom of the cylinder; a flow curve showing the relationship between piston stroke and temperature can be obtained from this.

In the present disclosure, the “melting temperature by the ½ method”, as described in the manual provided with the “Flowtester CFT-500D Flow Property Evaluation Instrument”, is used as the softening point.

The melting temperature by the ½ method is determined as follows.

First, ½ of the difference between the piston stroke Smax at the completion of outflow and the piston stroke Smin at the start of outflow is determined (this value is designated as X, where X=(Smax−Smin)/2). The temperature in the flow curve when the piston stroke in the flow curve reaches the sum of X and Smin is the melting temperature by the ½ method.

The measurement sample used is prepared by subjecting approximately 1.3 g of the sample to compression molding for 60 seconds at 10 MPa in a 25° C. environment using a tablet compression molder (for example, NT-100H, NPa System Co., Ltd.) to provide a cylindrical shape with a diameter of approximately 8 mm. The measurement conditions with the CFT-500D are as follows.

Test mode: ramp-up method
Start temperature: 50° C.
Saturated temperature: 200° C.
Measurement interval: 1.0° C.
Ramp rate: 4.0° C./min
Piston cross section area: 1.000 cm²
Test load (piston load): 10.0 kgf/cm² (0.9807 MPa)
Preheating time: 300 seconds
Diameter of die orifice: 1.0 mm
Die length: 1.0 mm

<Production Example of Silica Fine Particle S1-1>

A total of 1 kg of fumed silica (silica fine particle substrate; spherical) with a number average particle diameter of 40 nm was placed in a reaction vessel and heated while stirring in a nitrogen atmosphere. The temperature inside the vessel was controlled to 300° C. Next, double-terminal and side-chain epoxy type reactive silicone oil (chemical formula (1) below, kinematic viscosity at temperature of 25° C.: 45 mm²/s, functional group equivalent: 600 g/mol) was supplied into the reaction vessel, and treatment was performed in this state for 240 min to obtain silica fine particle S1-1. Table 1 shows the physical properties of the obtained silica fine particle.

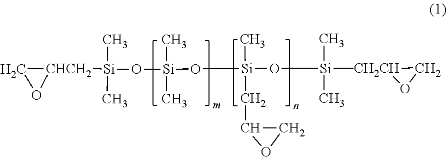

In chemical formula (1), m and n are positive integers, m is about 31, and n is about 3.

<Production of Silica Fine Particles S1-2 to S1-17>

Production was the same as that of silica fine particle S1-1, except that the treatment agent and treatment conditions for the fumed silica (silica fine particle substrate; spherical) having a number-average particle diameter as shown in Table 1 were changed as shown in Table 1.

The treatment agents shown in Table 1 are as follows.

Double-terminal alcohol type reactive silicone oil (chemical formula (2) below, kinematic viscosity at temperature of 25° C.: 40 mm²/s, functional group equivalent: 1000 g/mol)

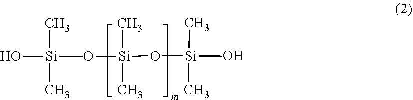

In chemical formula (2), m is a positive integer and is about 23 on average.

Double-terminal and side-chain alcohol type reactive silicone oil (chemical formula (3) below, kinematic viscosity at temperature of 25° C.: 55 mm²/s, functional group equivalent: 1500 g/mol)

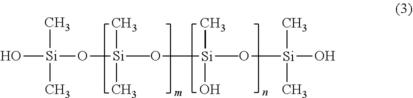

In chemical formula (3), m and n are positive integers, where m is about 73 and n is about 2.

Double-terminal and side-chain carbinol type reactive silicone oil (chemical formula (4) below, kinematic viscosity at a temperature of 25° C.: 42 mm²/s, functional group equivalent: 750 g/mol)

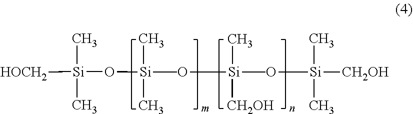

In chemical formula (4), m and n are positive integers, where m is about 33 and n is about 2.

<Production of Silica Fine Particle 51-18>

A total of 500 g of fumed silica (silica fine particle substrate) having a number-average particle diameter of 40 nm was placed in a reaction vessel, and the temperature inside the reaction vessel was controlled to 300° C. while stirring under a nitrogen purge. Next, as a surface treatment agent, a solution obtained by diluting 50 g of polydimethylsiloxane (kinematic viscosity at 25° C.: 50 mm²/s, average repeating unit number n=60) with 500 g of hexane was supplied by spraying with a sprayer. Then, a silica fine particle substrate was surface-treated by heating and stirring for 60 min to obtain silica fine particle S1-18.

<Production Example of Silica Fine Particles S1-19 and 20>

Production was the same as that of silica fine particle S1-18, except that the surface treatment agent and treatment conditions were changed as shown in Table 1.

TABLE 1

| | | | | | Number- | | | | |
|---|---|---|---|---|---|---|---|---|---|
| Silica | | Treatment | | | average | | | | Moisture |
| fine | | agent | Treatment | Treatment | particle | | | | adsorption |
| particle | | amount | temperature | time | diameter | | | | amount |
| S1 | Surface treatment agent | (parts) | (° C.) | (min) | (nm) | A/B | B | C | (cm³/m²) |
| 1 | Double-terminal and side-chain epoxy type | 2.2 | 300.0 | 240.0 | 40 | 11.7 | 8.8 | 8.8 | 0.020 |
| 2 | Double-terminal alcohol type | 2.2 | 300.0 | 240.0 | 40 | 11.5 | 8.6 | 8.6 | 0.020 |
| 3 | Double-terminal and side-chain alcohol type | 2.2 | 300.0 | 240.0 | 40 | 11.8 | 8.7 | 8.7 | 0.020 |
| 4 | Double-terminal and side-chain carbitol type | 2.2 | 300.0 | 240.0 | 40 | 11.2 | 8.8 | 8.5 | 0.021 |
| 5 | Double-terminal and side-chain epoxy type | 1.5 | 300.0 | 240.0 | 80 | 12.1 | 8.0 | 8.0 | 0.025 |
| 6 | Double-terminal and side-chain epoxy type | 2.5 | 300.0 | 240.0 | 30 | 9.8 | 8.8 | 8.8 | 0.016 |
| 7 | Double-terminal and side-chain epoxy type | 1.1 | 300.0 | 240.0 | 130 | 12.3 | 9.4 | 8.1 | 0.035 |
| 8 | Double-terminal and side chain epoxy type | 1.0 | 300.0 | 240.0 | 180 | 12.4 | 8.0 | 8.0 | 0.049 |
| 9 | Double-terminal and side-chain epoxy type | 1.0 | 300.0 | 180.0 | 180 | 12.6 | 9.1 | 8.6 | 0.051 |
| 10 | Double-terminal and side-chain epoxy type | 1.0 | 300.0 | 120.0 | 180 | 12.3 | 8.9 | 8.5 | 0.069 |
| 11 | Double-terminal and side-chain epoxy type | 1.0 | 270.0 | 120.0 | 180 | 13.1 | 8.8 | 6.4 | 0.070 |
| 12 | Double-terminal and side-chain epoxy type | 1.0 | 240.0 | 120.0 | 180 | 13.3 | 6.8 | 5.0 | 0.086 |
| 13 | Double-terminal and side-chain epoxy type | 1.0 | 240.0 | 120.0 | 200 | 13.4 | 6.8 | 3.0 | 0.087 |
| 14 | Double-terminal and side-chain epoxy type | 1.0 | 240.0 | 120.0 | 250 | 13.8 | 6.5 | 2.1 | 0.096 |
| 15 | Double-terminal and side-chain epoxy type | 0.9 | 240.0 | 120.0 | 500 | 14.0 | 6.4 | 1.2 | 0.098 |
| 16 | Double-terminal and side chain epoxy type | 0.8 | 240.0 | 120.0 | 12 | 4.8 | 15.6 | 1.2 | 0.026 |
| 17 | Double-terminal and side-chain epoxy type | 0.7 | 240.0 | 120.0 | 7 | 4.2 | 16.8 | 1.0 | 0.019 |
| 18 | Polydimethylsiloxane | 10.0 | 300.0 | 120.0 | 40 | 3.8 | 20.9 | 20.0 | 0.069 |
| 19 | Dimethyldichlorosilane | 10.0 | 300.0 | 60.0 | 40 | 14.8 | 6.4 | 6.4 | 0.186 |
| 20 | Polydimethylsiloxane | 10.0 | 250.0 | 120.0 | 40 | 5.6 | 17.6 | 0.9 | 0.101 |

<Toner Production Example 1>

| | |
|---|---|
| Binder resin 1 | 100 parts |
| Hydrocarbon wax (melting point 78° C.) | 4 parts |
| C.I. Pigment Blue 15:3 | 4 parts |

After premixing the above materials with a Henschel mixer (trade name: FM-10C type, manufactured by Nippon Coke Co., Ltd.), melt kneading was performed at 160° C. with a twin-screw kneading extruder.

The resulting kneaded product was cooled, coarsely pulverized with a hammer mill, and then finely pulverized with a turbo mill.

The resulting finely pulverized product was classified using a multi-division classifier utilizing the Coanda effect to obtain toner particles 1 having a weight-average particle diameter (D4) of 6.5 μm.

Next, silica fine particles were externally added to the obtained toner particles 1 as the first external addition treatment as described below.
Toner particle 1: 100 parts
Silica fine particle 51-1: 2.0 parts

The above ingredients were mixed with a Henschel mixer. The operating conditions of the Henschel mixer were a rotation speed of 4000 rpm, a rotation time of 2 min, and a heating temperature of room temperature.

After that, heat treatment was performed using the surface heat treatment apparatus shown in the Figure, and the silica fine particles were partially embedded in the toner particle surface. The operating conditions of the surface heat treatment apparatus were feed rate=1.0 kg/hr, hot air temperature=180° C., hot air flow rate=1.4 m³/min, cold air temperature=3° C., and cold air flow rate=1.2 m³/min.

Next, a wind force classifier (“ELBOW JET LAB EJ-L3”, manufactured by Nittetsu Mining Co., Ltd.) using the Coanda effect was used to classify and remove fine powder and coarse powder at the same time, and toner particles with the silica fine particle S1-1 embedded in the surface thereof were obtained. The heat-treated toner particles thus obtained were externally added with fine silica particles as a second external addition treatment as described below.
Toner particles 1 with the silica fine particle S1-1 embedded in the surface thereof: 100 parts
Silica fine particle 51-1: 0.6 parts

Using a Henschel mixer (trade name: FM-10C type, manufactured by Nippon Coke Co., Ltd.), the above materials were mixed at a rotation speed of 67 s⁻¹ (4000 rpm) for a rotation time of 2 min at an external addition temperature of room temperature. Toner 1 was obtained by passing through an ultrasonic vibrating sieve having a mesh opening of 54 Table 2 shows the surface treatment conditions for Toner 1.

<Toner Production Examples 2 to 22>

Production was carried out in the same manner as in Toner Production Example 1, except that the type and amount of a silica fine particle added and the treatment conditions were changed as shown in Table 2.

TABLE 2

| | | | | Surface |
|---|---|---|---|---|
| | | | Content of | treatment |
| | Toner base | Silica fine | silica fine | temperature |
| Toner | particle | particle S1 | particle S1 (parts) | of toner(° C.) |
| 1 | 1 | 1 | 2.60 | 180 |
| 2 | 1 | 2 | 2.60 | 180 |
| 3 | 1 | 3 | 2.60 | 180 |
| 4 | 1 | 4 | 2.60 | 180 |
| 5 | 1 | 5 | 2.60 | 180 |
| 6 | 1 | 5 | 2.60 | 170 |
| 7 | 1 | 5 | 2.00 | None |
| 8 | 1 | 6 | 2.00 | None |
| 9 | 1 | 7 | 2.00 | None |
| 10 | 1 | 8 | 2.00 | None |
| 11 | 1 | 9 | 2.00 | None |
| 12 | 1 | 10 | 2.00 | None |
| 13 | 1 | 11 | 2.00 | None |
| 14 | 1 | 12 | 2.00 | None |
| 15 | 1 | 13 | 2.00 | None |
| 16 | 1 | 14 | 2.00 | None |
| 17 | 1 | 15 | 2.00 | None |
| 18 | 1 | 16 | 2.00 | None |
| 19 | 1 | 17 | 2.00 | None |
| 20 | 1 | 18 | 2.00 | None |
| 21 | 1 | 19 | 2.00 | None |
| 22 | 1 | 20 | 2.00 | None |

<Production Example of Magnetic Carrier Core Particle 1>

[Step 1 (Weighing and Mixing Step)]

| | | |
|---|---|---|
| Fe₂O₃ | 68.3% | by mass |
| MnCO₃ | 28.5% | by mass |
| Mg(OH)₂ | 2.0% | by mass |
| SrCO₃ | 1.2% | by mass |

The ferrite raw materials were weighed, 20 parts of water was added to 80 parts of the ferrite raw materials, and then wet mixing was performed for 3 h in a ball mill using zirconia with a diameter of 10 mm to prepare a slurry. The solid content concentration of the slurry was set to 80% by mass.

[Step 2 (Pre-Baking Step)]

After drying the mixed slurry with a spray dryer (manufactured by Okawara Kakoki Co., Ltd.), baking was performed at a temperature of 1050° C. for 3.0 h in a batch type electric furnace under a nitrogen atmosphere (oxygen concentration 1.0% by volume) to produce a pre-baked ferrite.

[Step 3 (Pulverization Step)]

After pulverizing the pre-baked ferrite to about 0.5 mm with a crusher, water was added to prepare a slurry. The solid content concentration of the slurry was set to 70% by mass. The slurry was pulverized for 3 h in a wet ball mill using ⅛-inch stainless steel beads to obtain a slurry. Further, this slurry was pulverized for 4 h in a wet bead mill using zirconia with a diameter of 1 mm to obtain a pre-baked ferrite slurry having a volume-based 50% particle diameter (D50) of 1.3

[Step 4 (Granulation Step)]

After adding 1.0 parts of ammonium polycarboxylate as a dispersing agent and 1.5 parts of polyvinyl alcohol as a binder to 100 parts of the pre-baked ferrite slurry, the mixture was granulated into spherical particles using a spray dryer (manufactured by Okawara Kakohki Co., Ltd.) and dried. After adjusting the particle size of the obtained granules, they were heated at 700° C. for 2 h using a rotary electric furnace to remove organic substances such as the dispersing agent and binder.

[Step 5 (Firing Step)]

In a nitrogen atmosphere (oxygen concentration of 1.0% by volume), the time from room temperature to the firing temperature (1100° C.) was set to 2 h, and the granules were fired by holding at a temperature of 1100° C. for 4 h. Thereafter, the temperature was lowered to 60° C. over 8 h, the nitrogen atmosphere was returned to the air atmosphere, and the fired product was taken out at a temperature of 40° C. or lower.

[Step 6 (Sorting Step)]

After crushing the aggregated particles contained in the obtained fired product, coarse particles were removed by sieving with a 150-11m mesh sieve, fine powder was removed by air classification, and components with a low magnetic force were removed by magnetic separation to obtain porous magnetic core particles.

[Step 7 (Filling Step)]

A total of 100 parts of porous magnetic core particles 1 were placed in a stirring vessel of a mixing stirrer (universal stirrer NDMV type manufactured by Dalton Corporation), the temperature was maintained at 60° C., and 5 parts of a filling resin consisting of 95.0% by mass of a methyl silicone oligomer and 5.0% by mass of γ-aminopropyltrimethoxysilane was added dropwise at normal pressure.

After completion of dropping, stirring was continued while adjusting the time, the temperature was raised to 70° C., and each porous magnetic core particle was filled with the resin composition.

The resin-filled magnetic core particles obtained after cooling were transferred to a mixer (UD-AT type drum mixer manufactured by Sugiyama Heavy Industries Co., Ltd.) having spiral blades in a rotatable mixing container, and the temperature was raised to 140° C. with stirring at a heating rate of 2° C./min under a nitrogen atmosphere. After that, heating and stirring were continued at 140° C. for 50 min.

After cooling to room temperature, the resin-filled and cured ferrite particles were taken out, and non-magnetic substances were removed using a magnetic separator. Furthermore, coarse particles were removed with a vibrating sieve to obtain magnetic carrier core particles 1 filled with resin.

[Production Example of Coating Resin]

| | |
|---|---|
| Cyclohexyl methacrylate monomer | 26.8% by mass |
| Methyl methacrylate monomer | 0.2% by mass |
| Methyl methacrylate macromonomer | 8.4% by mass |

(a macromonomer with a weight-average molecular weight of 5000 having a methacryloyl group at one end; represented by formula (B), where A is a polymer of methyl methacrylate)

| | |
|---|---|
| Toluene | 31.3% by mass |
| Methyl ethyl ketone | 31.3% by mass |
| Azobisisobutyronitrile | 2.0% by mass |

Of the above materials, cyclohexyl methacrylate monomer, methyl methacrylate monomer, methyl methacrylate macromonomer, toluene, and methyl ethyl ketone were placed in a four-necked separable flask equipped with a reflux condenser, a thermometer, a nitrogen introduction tube, and a stirrer. After nitrogen gas was introduced into the separable flask to create a nitrogen atmosphere, the temperature was raised to 80° C., azobisisobutyronitrile was added, and the mixture was refluxed for 5 h for polymerization.

Hexane was injected into the resulting reaction product to precipitate a copolymer.

After the resulting precipitate was separated by filtration, it was vacuum-dried to obtain a resin.

A total of 30 parts of the obtained resin was dissolved in a mixed solvent of 40 parts of toluene and 30 parts of methyl ethyl ketone to obtain a resin solution (solid concentration: 30%).

[Preparation of Coating Resin Solution]

| | |
|---|---|
| Resin solution (solid content concentration 30%) | 33.3% by mass |
| Toluene | 66.4% by mass |
| Carbon black (REGAL 330; manufactured by Cabot | 0.3% by mass |
| Corporation) | |

(number-average particle diameter of primary particles: 25 nm, nitrogen adsorption specific surface area: 94 m²/g, DBP oil absorption: 75 ml/100 g)

The above materials were put into a paint shaker and dispersed for 1 h using zirconia beads with a diameter of 0.5 mm. The resulting dispersion liquid was filtered through a 5.0 μm membrane filter to obtain a coating resin solution.

<Production Example of Magnetic Carrier 1>

The coating resin solution and the magnetic carrier core particles 1 were added into a vacuum degassing kneader maintained at room temperature (the amount of the coating resin solution added was 2.5 parts as the resin component per 100 parts of the magnetic carrier core particles 1).

After the addition, the mixture was stirred at a rotation speed of 30 rpm for 15 min, and after the solvent was volatilized at or over a certain amount (80%), the temperature was raised to 80° C. while mixing under reduced pressure, toluene was distilled off over 2 h, and then the mixture was cooled.

The obtained magnetic carrier was subjected to magnetic separation to separate products with a low magnetic force, passed through a sieve with an opening of 70 and then classified with an air classifier to obtain magnetic carrier 1 with a 50% particle diameter (D50) of 38.2 μm based on volume distribution.

<Production Example of Magnetic Carrier 2>

A magnetic carrier 2 was obtained in the same manner as in the Production Example of Magnetic Carrier 1, except that the materials of the coating resin were changed as follows.

| | | |
|---|---|---|
| Cyclohexyl methacrylate monomer | 26.8% | by mass |
| Methyl methacrylate monomer | 8.6% | by mass |
| Toluene | 31.3% | by mass |
| Methyl ethyl ketone | 31.3% | by mass |
| Azobisisobutyronitrile | 2.0% | by mass |

<Production Example of Magnetic Carrier 3>

A magnetic carrier 3 was obtained in the same manner as in the Production Example of Magnetic Carrier 1, except that the materials of the coating resin were changed as follows.

| | |
|---|---|
| Methyl methacrylate monomer | 35.4% by mass |
| Toluene | 31.3% by mass |
| Methyl ethyl ketone | 31.3% by mass |
| Azobisisobutyronitrile | 2.0% by mass |

<Preparation of Two-Component Developer>

Toners 1 to 22 and magnetic carriers 1 to 3 were combined as shown in Table 3, and two-component developers 1 to 24 were prepared by mixing under the conditions of 0.5 s⁻¹ and a rotation time of 5 min by using a V-type mixer (V-10 type: Tokuju Corporation) so that the toner concentration was 8.0% by mass.

TABLE 3

| Developer | Toner | Magnetic carrier |
|---|---|---|
| 1 | 1 | 1 |
| 2 | 2 | 1 |
| 3 | 3 | 1 |
| 4 | 4 | 1 |
| 5 | 1 | 2 |
| 6 | 1 | 3 |
| 7 | 5 | 3 |
| 8 | 6 | 3 |
| 9 | 7 | 3 |
| 10 | 8 | 3 |
| 11 | 9 | 3 |
| 12 | 10 | 3 |
| 13 | 11 | 3 |
| 14 | 12 | 3 |
| 15 | 13 | 3 |
| 16 | 14 | 3 |
| 17 | 15 | 3 |
| 18 | 16 | 3 |
| 19 | 17 | 3 |
| 20 | 18 | 3 |
| 21 | 19 | 3 |
| 22 | 20 | 3 |
| 23 | 21 | 3 |
| 24 | 22 | 3 |

### <Examples 1 to 21 and Comparative Examples 1 to 3>

The following evaluations were performed using the obtained two-component developers 1 to 24. Tables 4-1 and 4-2 show the evaluation results.

### <Evaluation>

As the image forming apparatus, the imagePRESS C850 (manufactured by Canon Inc.) was used, the fixing unit was taken out so that the fixing temperature could be arbitrarily controlled, and modification was performed to yield an image formation speed of 105 sheets/min with an A4 size. In addition, the development contrast could be adjusted at any value, and the automatic correction by the main unit was disabled. The frequency of the alternating electric field was fixed at 2.0 kHz, and the peak-to-peak voltage (Vpp) was changed from 0.7 kV to 1.8 kV in increments of 0.1 kV.

The two-component developer was put into the developing device at the cyan position of this image forming apparatus, the charging voltage VD of the electrostatic latent image bearing member and the laser power were adjusted, and the evaluation described hereinbelow was performed. For the evaluation of stability over time and developing performance before and after continuous printing, the evaluation was performed at two levels of image formation speed: 105 sheets/min for A4 size and 85 sheets/min for A4 size.

White paper (trade name: CS-814 (A4, 81.4 g/m²), Canon Marketing Japan, Inc.) was used as the evaluation paper.

<Evaluation of Stability of Printed Images over Time>

Under normal temperature and normal humidity environment (temperature 23° C., humidity 50RH %, hereinafter also referred to as “N/N environment”), the development contrast of the copier main body was adjusted, the reflection density of the output image was measured with an optical densitometer, and the reflection density was set to be 1.48 to 1.52. Five images were output under the above image forming conditions, the densities of the output images were measured, the average was obtained, and the image density A was obtained.

Next, in a high-temperature and high-humidity environment (temperature 30° C./humidity 80RH %, hereinafter also referred to as “H/H environment”), the copier main body was allowed to stand in the H/H environment for 24 h while maintaining the development contrast set in N/N. Then, five images were output, the average was obtained, and the image density B was obtained. An X-Rite color reflection densitometer (manufactured by X-Rite, Inc.) was used as an optical densitometer.

Then, the density fluctuation difference shown by the following formula was calculated to evaluate the image density stability. Samples with the density fluctuation difference of less than 0.14 were determined to be good.

Density fluctuation difference=image density A−image density B1

[Evaluation Criteria]

A: less than 0.06
B: 0.06 or more and less than 0.10
C: 0.10 or more and less than 0.14
D: 0.14 or more and less than 0.18
E: 0.18 or more

<Evaluation of Developing Performance Before and After Continuous Printing>

Under an N/L environment, the initial Vpp was fixed at 1.3 kV, and the contrast potential was set so that the reflection density of the cyan single-color solid image was 1.50.

With this setting, 2000 sheets of an image pattern with a ratio of cyan single-color image to the paper surface of 1% were continuously output. Thereafter, a cyan single-color solid image was output again at Vpp of 1.3 kV, and the reflection density was measured. A contrast potential at which the reflection density of the cyan single-color solid image was 1.50 was obtained, and the difference from the initial value was compared. The reflection density was measured using a spectral densitometer 500 series (manufactured by X-Rite, Inc.). Samples with the rank D or higher were determined to be good.

[Evaluation Criteria]

AAA: The difference from the initial value is less than 30 V

AA: The difference from the initial value is 30 V or more and less than 35 V

A: The difference from the initial value is 35 V or more and less than 40 V
B: The difference from the initial value is 40 V or more and less than 60 V
C: The difference from the initial value is 60 V or more and less than 80 V
D: The difference from the initial value is 80 V or more and less than 100 V
E: The difference from the initial value is 100 V or more

<Evaluation of Development Spots (Toner Aggregation Property)>

The two-component developer was allowed to stand for three months in a high-temperature, high-humidity environment (30° C./95% Rh). After that, 300 sheets of 4A full-surface halftone images were output under a normal temperature and normal humidity environment (23° C./50% Rh), and the number of confirmed spots of toner aggregates per one A4 halftone output image was evaluated. The image output settings were set so that a reflection density on paper of 0.80 was obtained in halftone. The reflection density was measured using a spectral densitometer 500 series (manufactured by X-Rite, Inc.).

[Evaluation Criteria]

A: less than 0.01
B: 0.01 or more and less than 0.1
C: 0.1 or more and less than 0.5
D: 0.5 or more and less than 3.0
E: 3.0 or more

<Fogging Density>

The fogging density was measured in the following manner. Under the H/H environment, immediately after the 20,000th image was output using plain paper GF-C157 (A4, 157 g/cm²) for color copiers and printers (sold by Canon Marketing Japan, Inc.), a solid-white paper was passed through. Next, using “REFLECTMETER MODEL TC-6135” (manufactured by Tokyo Denshoku Co., Ltd.), the fogging density (%) was calculated from the difference between the whiteness of the white background portion of the measured image and the whiteness of the transfer paper. An amber filter was used as the filter. A smaller value indicates a better fogging level.

[Evaluation Criteria]

A: Fogging density less than 0.5%
B: Fogging density of 0.5% or more and less than 1.0%
C: Fogging density of 1.0% or more and less than 2.0%
D: Fogging density of 2.0% or more

TABLE 4-1

| | | | | Evaluation of developing performance before and after | | | |
|---|---|---|---|---|---|---|---|
| | | | | continuous printing | | | |
| | | Stability of printed image over time | | Image formation speed | | Image formation speed | |
| Evaluation | | Image formation | Image formation | 105 prints/min | | 85 prints/min | |
| Example/ | | speed | speed | Difference from | | Difference from | |
| Comparative | Two-component | 105 prints/min | 85 prints/min | initial potential | | initial potential | |
| Example | developer | Evaluation | Evaluation | value (V) | Evaluation | value (V) | Evaluation |
| Example 1 | Two-component | A | A | 29 | AAA | 29 | AAA |
| | developer 1 | | | | | | |
| Example 2 | Two-component | A | A | 29 | AAA | 29 | AAA |
| | developer 2 | | | | | | |
| Example 3 | Two-component | A | A | 30 | AAA | 30 | AAA |
| | developer 3 | | | | | | |
| Example 4 | Two-component | A | A | 30 | AAA | 30 | AAA |
| | developer 4 | | | | | | |
| Example 5 | Two-component | A | A | 31 | AA | 31 | AA |
| | developer 5 | | | | | | |
| Example 6 | Two-component | A | A | 33 | AA | 31 | AA |
| | developer 6 | | | | | | |
| Example 7 | Two-component | B | A | 38 | A | 36 | A |
| | developer 7 | | | | | | |
| Example 8 | Two-component | B | A | 45 | B | 38 | A |
| | developer 8 | | | | | | |
| Example 9 | Two-component | B | A | 48 | B | 38 | A |
| | developer 9 | | | | | | |
| Example 10 | Two-component | B | A | 55 | B | 39 | A |
| | developer 10 | | | | | | |
| Example 11 | Two-component | B | A | 57 | B | 40 | A |
| | developer 11 | | | | | | |
| Example 12 | Two-component | C | B | 58 | B | 51 | B |
| | developer 12 | | | | | | |
| Example 13 | Two-component | C | B | 68 | C | 55 | B |
| | developer 13 | | | | | | |
| Example 14 | Two-component | C | C | 70 | C | 65 | C |
| | developer 14 | | | | | | |
| Example 15 | Two-component | C | C | 79 | C | 72 | C |
| | developer 15 | | | | | | |
| Example 16 | Two-component | D | C | 93 | D | 78 | C |
| | developer 16 | | | | | | |
| Example 17 | Two-component | D | C | 93 | D | 78 | C |
| | developer 17 | | | | | | |
| Example 18 | Two-component | D | C | 95 | D | 83 | D |
| | developer 18 | | | | | | |
| Example 19 | Two-component | D | D | 98 | D | 88 | D |
| | developer 19 | | | | | | |
| Example 20 | Two-component | D | D | 99 | D | 92 | D |
| | developer 20 | | | | | | |
| Example 21 | Two-component | D | D | 99 | D | 92 | D |
| | developer 21 | | | | | | |
| Comparative | Two-component | E | D | 113 | E | 101 | E |
| Example 1 | developer 22 | | | | | | |
| Comparative | Two-component | E | E | 115 | E | 104 | E |
| Example 2 | developer 23 | | | | | | |
| Comparative | Two-component | E | E | 117 | E | 107 | E |
| Example 3 | developer 24 | | | | | | |

TABLE 4-2

| Evaluation | | Development spots | | Fogging | |
|---|---|---|---|---|---|
| Example/ | | H/H environment | | H/H environment | |
| Comparative | Two-component | | Eval- | Fogging | Eval- |
| Example | developer | Number | uation | density | uation |
| Example 1 | Two-component | 0 | A | 0.1 | A |
| | developer 1 | | | | |
| Example 2 | Two-component | 0 | A | 0.1 | A |
| | developer 2 | | | | |
| Example 3 | Two-component | 0 | A | 0.1 | A |
| | developer 3 | | | | |
| Example 4 | Two-component | 0 | A | 0.2 | A |
| | developer 4 | | | | |
| Example 5 | Two-component | 0 | A | 0.2 | A |
| | developer 5 | | | | |
| Example 6 | Two-component | 0 | A | 0.3 | A |
| | developer 6 | | | | |
| Example 7 | Two-component | 0 | A | 0.3 | A |
| | developer 7 | | | | |
| Example 8 | Two-component | 0.003 | A | 0.3 | A |
| | developer 8 | | | | |
| Example 9 | Two-component | 0.010 | B | 0.3 | A |
| | developer 9 | | | | |
| Example 10 | Two-component | 0.013 | B | 0.3 | A |
| | developer 10 | | | | |
| Example 11 | Two-component | 0.013 | B | 0.4 | A |
| | developer 11 | | | | |
| Example 12 | Two-component | 0.033 | B | 0.4 | A |
| | developer 12 | | | | |
| Example 13 | Two-component | 0.13 | C | 0.4 | A |
| | developer 13 | | | | |
| Example 14 | Two-component | 0.18 | C | 0.5 | B |
| | developer 14 | | | | |
| Example 15 | Two-component | 0.21 | C | 0.7 | B |
| | developer 15 | | | | |
| Example 16 | Two-component | 0.24 | C | 1.2 | C |
| | developer 16 | | | | |
| Example 17 | Two-component | 0.53 | D | 1.3 | C |
| | developer 17 | | | | |
| Example 18 | Two-component | 0.89 | D | 1.3 | C |
| | developer 18 | | | | |
| Example 19 | Two-component | 1.15 | D | 1.6 | C |
| | developer 19 | | | | |
| Example 20 | Two-component | 1.28 | D | 1.7 | C |
| | developer 20 | | | | |
| Example 21 | Two-component | 1.28 | D | 1.7 | C |
| | developer 21 | | | | |
| Comparative | Two-component | 5.28 | E | 2.5 | D |
| Example 1 | developer 22 | | | | |
| Comparative | Two-component | 6.22 | E | 2.8 | D |
| Example 2 | developer 23 | | | | |
| Comparative | Two-component | 7.08 | E | 2.7 | D |
| Example 3 | developer 24 | | | | |

In addition, the present disclosure relates to the following configurations.

### (Configuration 1)

A toner comprising

a toner particle comprising a binder resin, and

a silica fine particle S1 on a surface of the toner particle, wherein

the toner has a weight-average particle diameter of 4.0 μm or more and 15.0 μm or less,

where in ²⁹Si-NMR measurement of the silica fine particle S1, peaks corresponding to the silica fine particle S1 are observed,

in a spectrum obtained by a 29 Si-NMR·CP/MAS method for the silica fine particle S1, a peak corresponding to a D1 unit structure of the silica fine particle S1, a peak corresponding to a D2 unit structure of the silica fine particle S1, and a peak corresponding to a Q unit structure of the silica fine particle S1 are present, and a peak area of the peak corresponding to the D1 unit structure, a peak area of the peak corresponding to the D2 unit structure, and a peak area of the peak corresponding to the Q unit structure are denoted by S_{CP}D1, S_{SC}D2, and S_{CP}Q, respectively, and

in a spectrum obtained by a ²⁹Si-NMR·DD/MAS method for the silica fine particle S1, a peak corresponding to a D1 unit structure of the silica fine particle S1, a peak corresponding to a D2 unit structure of the silica fine particle S1, and a peak corresponding to a Q unit structure of the silica fine particle S1 are present, and a peak area of the peak corresponding to the D1 unit structure, a peak area of the peak corresponding to the D2 unit structure, and a peak area of the peak corresponding to the Q unit structure are denoted by S_{DD}D1, S_{DD}D2, and S_{DD}Q, respectively, the ratio (AB) of A given by a following formula (1) to B given by a following formula (2) is 4.0 or more and 14.0 or less,

A={(S_{CP}D1+S_{CP}D2)/S_{CP}Q}×100

B={(S_{DD}D1+S_{DD}D2)/S_{DD}Q}×100, and

where in a spectrum obtained by the ²⁹Si-NMR·DD/MAS method for a sample obtained by washing the silica fine particle S1 with hexane, a peak corresponding to the D1 unit structure of the sample, a peak corresponding to the D2 unit structure of the sample, and a peak corresponding to the Q unit structure of the sample are present, and a peak area of the peak corresponding to the D1 unit structure, a peak area of the peak corresponding to the D2 unit structure, and a peak area of the peak corresponding to the Q unit structure are denoted by S_{DDW}D1, S_{DDW}D2, and S_{DDW}Q, respectively, a value of C given by a following formula (3) is 1.0 or more.

C={(S_{DDW}D1+S_{DDW}D2)/S_{DDW}Q}×100

### (Configuration 2)

The toner according to configuration 1, wherein the value of C is 5.0 or more. (Configuration 3)

The toner according to configuration 1 or 2, wherein the silica fine particle S1 have a number-average particle size of 5.0 nm or more and 500.0 nm or less.

### (Configuration 4)

The toner according to any of configurations 1 to 3, wherein the silica fine particle S1 have a moisture adsorption amount of 0.010 cm³/m² to 0.100 cm³/m² per 1 m² of BET specific surface area at a temperature of 30° C. and a relative humidity of 80%.

### (Configuration 5)

A two-component developer comprising a toner and a magnetic carrier, wherein

the magnetic carrier comprises a magnetic carrier core particle and a resin coating layer formed on the surface of the magnetic carrier core particle, and

the toner is the toner according to any of configurations 1 to 4.

### (Configuration 6)

The two-component developer according to configuration 5, wherein

a resin in the resin coating layer has

a monomer unit corresponding to a (meth)acrylic acid ester having an alicyclic hydrocarbon group, and

a monomer unit corresponding to a macromonomer represented by a following formula (B).

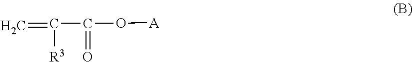

(in formula (B), A is a polymer of at least one compound selected from the group consisting of methyl acrylate, methyl methacrylate, butyl acrylate, butyl methacrylate, 2-ethylhexyl acrylate, and 2-ethylhexyl methacrylate. R³ is H or CH₃.)

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

What is claimed is:

1. A toner comprising
a toner particle comprising a binder resin, and
a silica fine particle S1 on a surface of the toner particle, wherein
the toner has a weight-average particle diameter of 4.0 μm or more and 15.0 μm or less,
where in ²⁹Si-NMR measurement of the silica fine particle S1, peaks corresponding to the silica fine particle S1 are observed,
in a spectrum obtained by a ²⁹Si-NMR·CP/MAS method for the silica fine particle S1, a peak corresponding to a D1 unit structure of the silica fine particle S1, a peak corresponding to a D2 unit structure of the silica fine particle S1, and a peak corresponding to a Q unit structure of the silica fine particle S1 are present, and a peak area of the peak corresponding to the D1 unit structure, a peak area of the peak corresponding to the D2 unit structure, and a peak area of the peak corresponding to the Q unit structure are denoted by S_{CP}D1, S_{CP}D2, and S_{CP}Q, respectively, and
in a spectrum obtained by a ²⁹Si-NMR·DD/MAS method for the silica fine particle S1, a peak corresponding to a D1 unit structure of the silica fine particle S1, a peak corresponding to a D2 unit structure of the silica fine particle S1, and a peak corresponding to a Q unit structure of the silica fine particle S1 are present, and a peak area of the peak corresponding to the D1 unit structure, a peak area of the peak corresponding to the D2 unit structure, and a peak area of the peak corresponding to the Q unit structure are denoted by S_{DD}D1, S_{DD}D2, and S_{DD}Q, respectively, the ratio (AB) of A given by a following formula (1) to B given by a following formula (2) is 4.0 or more and 14.0 or less,
A={(S_{CP}D1+S_{CP}D2)/S_{CP}Q}×100
B={(S_{DD}D1+S_{DD}D2)/S_{DD}Q}×100, and
where in a spectrum obtained by the ²⁹Si-NMR·DD/MAS method for a sample obtained by washing the silica fine particle S1 with hexane, a peak corresponding to the D1 unit structure of the sample, a peak corresponding to the D2 unit structure of the sample, and a peak corresponding to the Q unit structure of the sample are present, and a peak area of the peak corresponding to the D1 unit structure, a peak area of the peak corresponding to the D2 unit structure, and a peak area of the peak corresponding to the Q unit structure are denoted by S_{DDW}D1, S_{DDW}D2, and S_{DDW}Q, respectively, a value of C given by a following formula (3) is 1.0 or more;
C={(S_{DDW}D1+S_{DDW}D2)/S_{DDW}Q}×100.

2. The toner according to claim 1, wherein the value of C is 5.0 or more.

3. The toner according to claim 1, wherein the silica fine particle S1 have a number-average particle size of 5.0 nm or more and 500.0 nm or less.

4. The toner according to claim 1, wherein the silica fine particle S1 have a moisture adsorption amount of 0.010 cm³/m² to 0.100 cm³/m² per 1 m² of BET specific surface area at a temperature of 30° C. and a relative humidity of 80%.

5. A two-component developer comprising a toner and a magnetic carrier, wherein
the magnetic carrier comprises a magnetic carrier core particle and a resin coating layer formed on the surface of the magnetic carrier core particle, and the toner is the toner according to claim 1.

6. The two-component developer according to claim 5, wherein a resin in the resin coating layer has
a monomer unit corresponding to a (meth)acrylic acid ester having an alicyclic hydrocarbon group, and
a monomer unit corresponding to a macromonomer represented by a following formula (B); 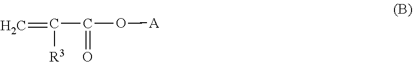
(in formula (B), A is a polymer of at least one compound selected from the group consisting of methyl acrylate, methyl methacrylate, butyl acrylate, butyl methacrylate, 2-ethylhexyl acrylate, and 2-ethylhexyl methacrylate. R³ is H or CH³.).
